(19) United States
(12) Patent Application Publication
(10) Pub. No.: US 2014/0126690 A1
(43) Pub. Date: May 8, 2014

(54) X-RAY IMAGING APPARATUS AND X-RAY IMAGING SYSTEM

(71) Applicant: CANON KABUSHIKI KAISHA, Tokyo (JP)

(72) Inventor: Kimiaki Yamaguchi, Tokyo (JP)

(73) Assignee: CANON KABUSHIKI KAISHA, Tokyo (JP)

(21) Appl. No.: 14/069,838

(22) Filed: Nov. 1, 2013

(30) Foreign Application Priority Data
Nov. 6, 2012 (JP) 2012-244598

(51) Int. Cl. G01N 23/20

(52) U.S. Cl. CPC G01N 23/20075
USPC 378/36

(57) ABSTRACT

An X-ray imaging apparatus includes an optical device configured to form a periodic pattern using X-rays radiated from an X-ray source, an alignment mark of the optical device, a first detector, a second detector, and a movement unit configured to change at least either a position of the optical device or an angle of the optical device on the basis of a result of detection performed by the second detector. The first detector detects X-rays that have passed through the optical device and a subject, and the second detector detects X-rays that have passed through the alignment mark. The movement unit includes a movement instruction section that instructs the optical device to move on the basis of the result of the detection performed by the second detector and movement sections that move the optical device on the basis of the instruction issued by the movement instruction section.

### BACKGROUND OF THE INVENTION

1. Field of the Invention

The present invention relates to an X-ray imaging apparatus and an X-ray imaging system.

2. Description of the Related Art

In these years, imaging methods called “X-ray phase contrast imaging” are being developed in which contrast is generated on the basis of changes in the phases of X-rays that have passed through a subject. As one of such X-ray phase contrast imaging methods, an imaging method called “X-ray Talbot interferometry” that uses Talbot interference has been proposed in International Publication No. WO 04/058070.

An outline of the X-ray Talbot interferometry will be described. In imaging realized by the X-ray Talbot interferometry, an X-ray imaging apparatus including an X-ray source whose spatial coherence is high, an diffraction grating that diffracts X-rays and that forms an interference pattern (self-image) having a light/dark period at a certain position, and a detector that detects the X-rays is necessary. When a subject is disposed between the X-ray source and the diffraction grating or between the diffraction grating and the detector, the phases of X-rays radiated from the X-ray source are changed by the subject. The X-rays whose phases have been changed by the subject in turn change the shape of the self-image, and therefore the distribution (phase image) of phase change rates of the subject may be obtained on the basis of changes in the self-image caused by the subject.

In order to detect the self-image, however, a detector whose spatial resolution is high needs to be introduced, the length of the X-ray imaging apparatus needs to be increased, or an absorption grating needs to be introduced because the period of the self-image is short. The absorption grating is a grating in which screening portions that screen X-rays and propagation portions that propagate X-rays are periodically arranged. By disposing the screening grating at a position at which the self-image is formed, a moiré fringe is generated due to overlap between the self-image and the absorption grating. That is, when the absorption grating is used, information regarding changes in the phases of the X-rays caused by the subject may be detected by the detector as changes in the shape of the moiré fringe.

When the absorption grating is introduced, the period of the moiré fringe detected by the detector is adjusted by adjusting (aligning) the relative positions and the relative angles of the diffraction grating and the absorption grating.

When the absorption grating is not introduced and the self-image is directly detected by the detector, the relative positions and the relative angles of the X-ray source, the diffraction grating, and the detector need to be aligned with one another.

In Japanese Patent Laid-Open No. 2011-227041 (corresponding family: US 2011/0243300), an X-ray imaging apparatus is disclosed in which a detector detects X-rays that have passed through only a diffraction grating without passing through a subject and an absorption grating and alignment of the diffraction grating and the absorption grating is performed on the basis of a result of the detection.

When the subject is imaged using the above-described X-ray imaging apparatuses, the relative positions and the relative angles of the X-ray source, the diffraction grating, the absorption grating, and the detector might change during the imaging of the subject. In order to reduce such changes during the imaging, alignment may be performed during the imaging of the subject.

When alignment is performed on the basis of a result of detection as in the case of the X-ray imaging apparatus disclosed in Japanese Patent Laid-Open No. 2011-227041, a result of detection needs to be obtained for each operation of alignment. For example, when alignment is performed at intervals of 0.1 second (10 Hz) during the imaging of the subject, a result of detection needs to be obtained at intervals of 0.1 second. In order to perform alignment at intervals of 0.1 second and image the subject by exposing the subject for 10 seconds, one hundred results of detection obtained in 10 seconds at intervals of 0.1 second may be combined.

In general, however, a detector generates read noise (or readout noise) in each operation of detection. Therefore, the combined one hundred results of detection obtained at intervals of 0.1 second include larger read noise than a single result of detection obtained by exposing the subject for 10 seconds.

Thus, when alignment is performed using results of detection of X-rays while the subject is being imaged, read noise corresponding to the number of times of operations for detecting X-rays performed for the alignment affects a result of the imaging of the subject.

### SUMMARY OF THE INVENTION

An X-ray imaging apparatus according to an aspect of the present invention includes an optical device configured to form a periodic pattern using X-rays radiated from an X-ray source, an alignment mark of the optical device, a first detector configured to detect X-rays that have passed through the optical device and a subject; a second detector configured to detect X-rays that have passed through the alignment mark, and a movement unit configured to move the optical device on the basis of a result of the detection performed by the second detector.

Further features of the present invention will become apparent from the following description of exemplary embodiments with reference to the attached drawings.

### BRIEF DESCRIPTION OF THE DRAWINGS

FIG. 1 is a schematic diagram illustrating an X-ray phase imaging apparatus according to a first embodiment and a second embodiment of the present invention.

FIG. 2 is a schematic diagram illustrating the configuration of detectors according to the first embodiment of the present invention.

FIGS. 3A to 3C are schematic diagrams illustrating types of absorption grating according to the first embodiment of the present invention.

FIG. 4 is a schematic diagram illustrating provided alignment marks according to the first embodiment of the present invention.

FIG. 5 is a schematic diagram illustrating a method for analyzing an alignment mark according to the first embodiment of the present invention.

FIGS. 6A to 6D are schematic diagrams illustrating a method for analyzing an alignment mark according to the first embodiment of the present invention.

FIG. 7 is a schematic diagram illustrating an X-ray phase imaging apparatus according to the first embodiment of the present invention.

FIGS. 8A to 8F are schematic diagrams illustrating alignment according to the first embodiment of the present invention.

FIGS. 9A to 9E are schematic diagrams illustrating alignment marks according to the first embodiment of the present invention.

FIG. 10 is a schematic diagram illustrating an X-ray phase imaging apparatus according to the first embodiment of the present invention.

FIG. 11 is a schematic diagram illustrating an X-ray phase imaging apparatus according to the first embodiment of the present invention.

FIG. 12 is a schematic diagram illustrating the configuration of detectors according to the second embodiment of the present invention.

FIGS. 13A and 13B are schematic diagrams illustrating alignment patterns according to the second embodiment of the present invention.

FIGS. 14A to 14D are schematic diagrams illustrating a method for analyzing the alignment patterns according to the second embodiment of the present invention.

FIGS. 15A to 15D are schematic diagrams illustrating a method for analyzing the alignment patterns according to the second embodiment of the present invention.

FIGS. 16A to 16D are schematic diagrams illustrating a method for analyzing the alignment patterns according to the second embodiment of the present invention.

FIGS. 17A to 17C are schematic diagrams illustrating alignment patterns according to a third embodiment of the present invention.

FIGS. 18A to 18D are schematic diagrams illustrating alignment patterns according to the third embodiment of the present invention.

### DESCRIPTION OF THE EMBODIMENTS

An outline of preferred embodiments of the present invention will be described.

An X-ray imaging apparatus according to the preferred embodiments of the present invention includes an optical device, an alignment mark of the optical device, a first detector that detects X-rays that have passed through the optical device and a subject, and a second detector that detects X-rays from the alignment mark of the optical device. Furthermore, the X-ray imaging apparatus includes a movement unit that moves the optical device on the basis of a result of the detection performed by the second detector. A result of the detection performed by the first detector is transmitted to a calculator and used for obtaining information regarding the subject (imaging the subject). On the other hand, the result of the detection performed by the second detector is transmitted to the calculator and used for obtaining at least either information regarding the position of the optical device or information regarding the angle of the optical device (hereinafter referred to as information regarding the optical device). The information regarding the optical device includes, for example, relative positions and relative angles of the optical device and the detectors. In the case of an X-ray imaging apparatus including a plurality of optical devices, the information regarding the optical devices includes relative positions and relative angles of the optical devices. The amount of alignment of the optical device is obtained from the information regarding the optical device obtained by the calculator.

By independently performing the detection for obtaining the information regarding the subject and the detection for obtaining the information regarding the optical device, it becomes possible to reduce the effect of read noise generated when a detector obtains the information regarding the optical device upon a result of imaging for obtaining the information regarding the subject. The calculator to which the result of the detection performed by the second detector is transmitted may be the same calculator to which the result of the detection performed by the first detector is transmitted, or may be a different calculator. That is, a single calculator may perform both calculation for obtaining the information regarding the subject and calculation for obtaining the information regarding the optical device, or a plurality of calculators may perform such calculation. Alternatively, the calculation for obtaining the information regarding the subject and the calculation for obtaining the information regarding the optical device may each be performed by a plurality of calculators.

The read noise caused by the detectors herein refers to, in noise generated between the detector and the calculator, noise generated in accordance with the number of times that the calculator obtains a result of detection. For example, the read noise includes noise generated when charge is read from detection elements included in the detectors and noise generated when read information is transmitted to the calculator.

The first and second detectors need to perform detection independently of each other, and, for example, two detectors whose exposure times are different from each other may be used, or a single detector may both serve as the first detector and the second detector insofar as the detector is capable of setting exposure time for each region of a detection range. In the latter case, a region of the detection range in which the information regarding the subject is obtained is referred to as the first detector, and a region of the detection range in which the information regarding the optical device is obtained is referred to as the second detector. Alternatively, detectors that read charge a plurality of times during exposure may be used as the first detector and the second detector. When such detectors are used, the effect of read noise may be reduced if the number of times that the first detector transmits a result of detection to the calculator is smaller than the number of times that the second detector transmits a result of detection to the calculator even when charge reading periods of the first detector and the second detector are the same.

The alignment mark of the optical device needs to obtain at least either the information regarding the position of the optical device or information regarding the attitude of the optical device, and, for example, part of the optical device may be used as the alignment mark. In this case, the part of the optical device used for alignment is referred to as the alignment mark. The alignment mark of the optical device may be formed on a substrate of the optical device because it becomes easier to obtain the information regarding the optical device.

Other specific examples of the alignment mark will be described later.

The imaging herein is not limited to obtaining an image based on the information regarding the subject. For example, obtaining the information regarding the subject as values is also referred to as imaging. In X-ray Talbot interferometry, for example, differential phase information is obtained as the information regarding the subject, and a differential phase image of the subject is obtained by imaging the differential phase information. At this time, the differential phase information is obtained by detecting (that is, imaging) the intensity distribution of X-rays that have passed through the subject using a detector in which pixels are arranged in two dimensions and using a result of the detection. Therefore, an apparatus that does not obtain a phase difference image but obtains phase difference information is regarded as an imaging apparatus herein.

The preferred embodiments of the present invention will be described in more detail hereinafter with reference to the accompanying drawings. In the drawings, the same components are given the same reference numerals, and redundant description is omitted.

### First Embodiment

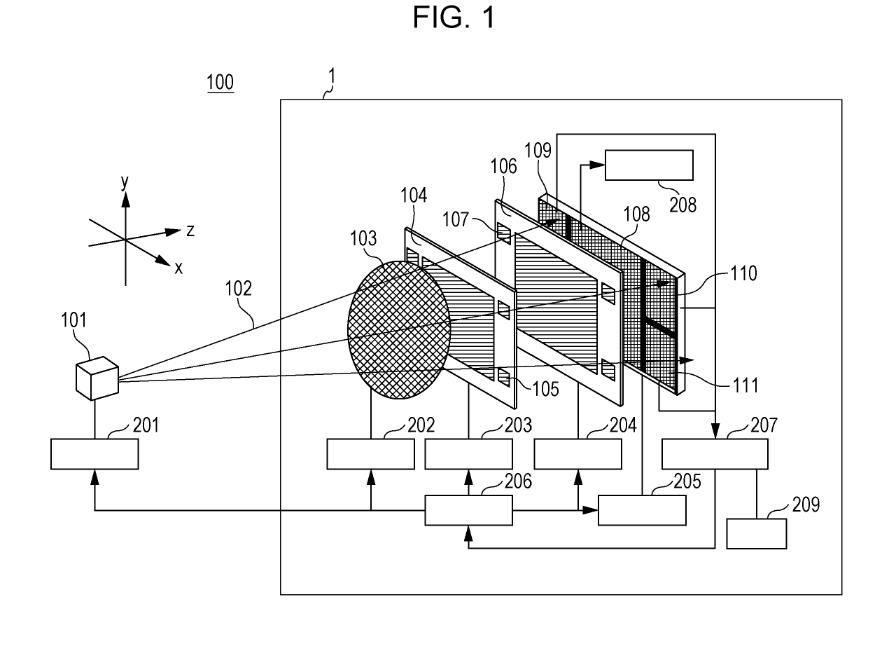

FIG. 1 is a schematic diagram illustrating the configuration of an X-ray imaging apparatus according to a first embodiment. An X-ray imaging apparatus 1 illustrated in FIG. 1 includes a diffraction grating (hereinafter referred to as a first grating) as a first optical device and an absorption grating (hereinafter referred to as a second grating) as a second optical device. A first grating 104 diffracts X-rays 102 radiated from an X-ray source 101. A second grating 106 screens part of the X-rays from the first grating 104. The X-ray imaging apparatus 1 further includes a detection unit that detects X-rays from the second grating 106, a movement unit that moves some components of the X-ray imaging apparatus 1, and calculators that calculate information regarding a subject and the amount of alignment of each component on the basis of a result of the detection performed by the detection unit. The amount of alignment of each component refers to the amount by which each component is moved to perform alignment. Alternatively, the X-ray imaging apparatus 1 may configure an X-ray imaging system 100 along with the X-ray source 101 and an image display unit (not illustrated). As the X-ray source 101, an X-ray source that radiates continuous X-rays or an X-ray source that radiates characteristic X-rays may be used. In addition, a grating (hereinafter referred to as a source grating) that divides the X-rays 102 radiated from the X-ray source 101 into thin beams may be provided along propagation paths of the X-rays 102, and, in such a case, the source grating is regarded as part of the X-ray source 101.

The components of the X-ray imaging apparatus 1 will be described in more detail hereinafter.

The first grating 104 in this embodiment is an optical device that forms an interference pattern (hereinafter referred to as a self-image), which is a type of periodic pattern, and the second grating 106 is an optical device that forms a moiré fringe, which is a type of periodic pattern. The periodic patterns are not limited to ones having constant periods, and, for example, patterns whose pitches change from the center to the periphery and patterns whose pitches change from the top to the bottom are also referred to as periodic patterns. In the following description, the “first grating” refers to a first grating region, and the “second grating” refers to a second grating region.

As the first grating 104, a phase diffraction grating (phase grating) that modulates the phases of X-rays may be used, or an amplitude (intensity) diffraction grating that modulates the intensity of X-rays. As the second grating 106, in general, an absorption grating that screens X-rays by absorbing the X-rays are often used, but a reflective absorption grating that screens X-rays by reflecting the X-rays may be used, instead. An X-ray screening portion of the absorption grating need not completely screen X-rays. When a moiré fringe is to be formed, X-rays need to be screened to an extent that the moiré fringe may be formed, and it is sufficient if about 80% of incident X-rays are screened.

Alignment of the diffraction grating 104 may be performed by detecting X-rays that have passed through or that have been reflected from alignment marks (hereinafter referred to as first alignment marks) 105 (105a to 105c) of the diffraction grating 104. In addition, alignment of the second grating 106 may be performed by detecting X-rays that have passed through or that have been reflected from alignment marks (hereinafter referred to as second alignment marks) 107 (107a to 107c) of the absorption grating 106. In the following description, the first alignment marks and the second alignment marks will be simply referred to as alignment marks. In order to easily realize accurate alignment, the first alignment marks 105 may be located in the same plane as the first grating 104, and the second alignment marks 107 may be located in the same plane as the second grating 106. In order to do so, the alignment marks may be provided on the same substrates as the gratings.

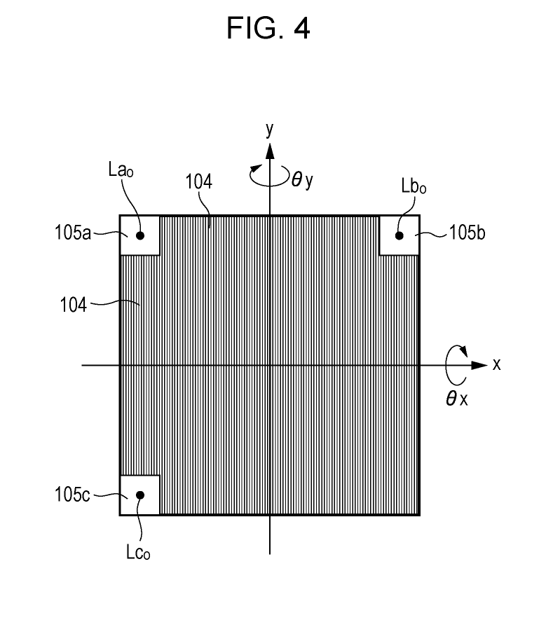

Three or more alignment marks 105 and three or more alignment marks 107 may be provided. Positions at which the alignment marks are provided are not particularly limited, but the alignment marks may be provided not randomly but in accordance with a certain rule because it becomes easier to perform calculation necessary for the alignment. In this embodiment, as illustrated in FIG. 4, the first alignment marks 105 are provided at three corners of the first grating 104. Similarly, the second alignment marks 107 are provided at three corners of the second grating 106.

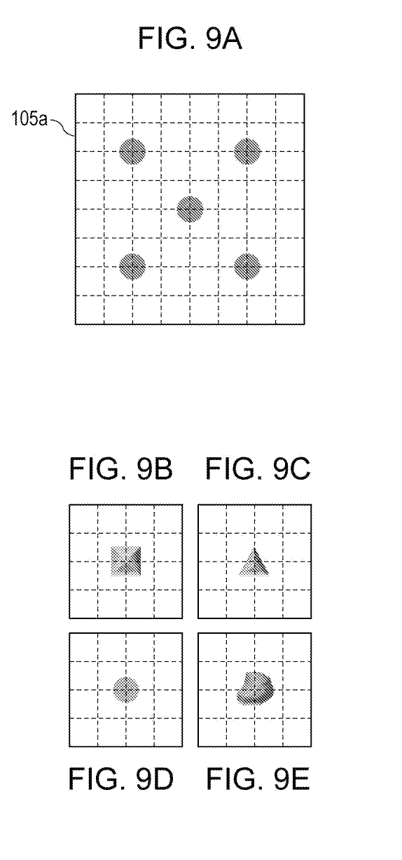

The alignment marks 105 and 107 according to this embodiment include regions in which the intensity distribution of X-rays is changed by locally absorbing the X-rays. When such alignment marks are used, the amount of absorption of X-rays may be large at a certain point as indicated by a square pyramid and a triangular pyramid illustrated in FIGS. 9B and 9C, respectively. However, the alignment marks may have a spherical shape or a disc shape illustrated in FIG. 9D in which there is no singular point of absorption, or may have a distorted shape illustrated in FIG. 9E in which two or more singular points of absorption are included. The material of the alignment marks may be a material that may absorb a large number of X-rays, such as gold or lead.

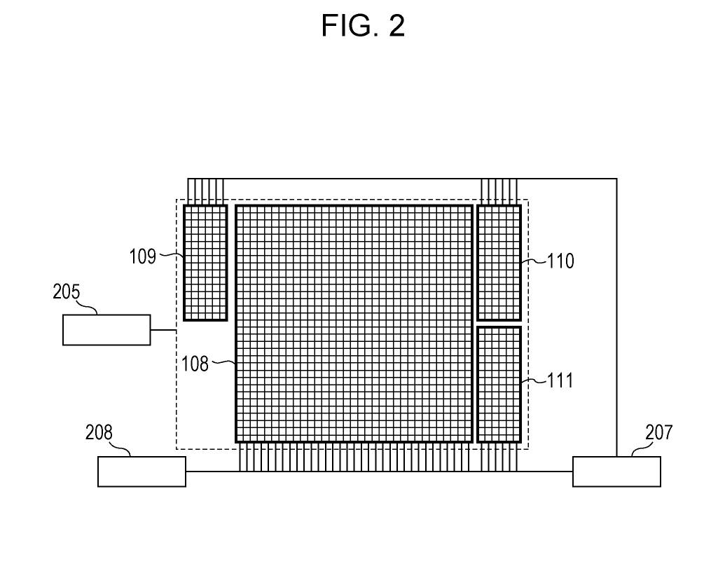

The detection unit includes a first detector 108, a second detector 109, a third detector 110, and a fourth detector 111. The first detector 108 may detect the intensity of X-rays that have passed through the first grating 104 and the second grating 106. The second detector 109, the third detector 110, and the fourth detector 111 may detect the intensity of X-rays that have passed through the alignment marks 105 and the alignment marks 107. FIG. 2 is a schematic diagram illustrating the detection unit. As illustrated in FIG. 2, the first to fourth detectors 108 to 111 are integrated with one another. In addition, the first to fourth detectors 108 to 111 may read results of detection independently of one another. The exposure time of the first detector 108 capable of detecting the intensity distribution of X-rays that have passed through a subject 103 may be set in accordance with time for which the subject 103 is to be exposed. In addition, the exposure times of the second to fourth detectors 109 to 111 may be set in accordance with intervals at which alignment information is to be obtained. By making periods at which the second to fourth detectors 109 to 111 read results of detection shorter than the exposure time of the first detector 108, alignment of the first grating 104 and the second grating 106 may be performed a plurality of times while the first detector 108 is performing detection once. Although a total of three detectors, namely the second to fourth detectors 109 to 111, are used for the alignment in this embodiment, the number of detectors used for the alignment may be one or more.

The movement unit includes a movement section 202 that moves a subject platform 113 on which the subject 103 is disposed, a movement section 203 that moves the first grating 104, a movement section 204 that moves the second grating 106, and a movement section 205 that moves the detection unit.

The movement sections 202 to 205 are not particularly limited insofar as the movement sections 202 to 205 are capable of mechanically moving the corresponding components, and may each include an actuator, a stepping motor, and a piezoelectric element. The movement sections 202 to 205 perform alignment by moving the corresponding components on the basis of the amounts of alignment of the corresponding components calculated by the calculators, which will be described hereinafter.

The calculators include a calculator 208 that calculates subject information from subject imaging information obtained by the first detector 108, a calculator 207 that calculates the amount of alignment of each component of the X-ray imaging apparatus 1 from the alignment information obtained by each of the second to fourth detectors 109 to 111, and a memory 209.

When the X-ray imaging apparatus 1 is included in the X-ray imaging system 100 as illustrated in FIG. 1, the X-ray imaging system 100 may include a movement section 201 that moves the X-ray source 101. When the X-ray imaging system 100 includes the movement section 201 for the X-ray source 101, the movement section 201 for the X-ray source 101 and the calculator 207 that calculates the amounts of alignment of the X-ray imaging apparatus 1 may be connected to each other, and the calculator 207 may calculate the amount of alignment of the X-ray source 101.

An example of an alignment method used by the X-ray imaging system 100 according to this embodiment will be described. Here, a method in which information regarding the positions and the attitudes of the first grating 104 and the second grating 106 is calculated independently of each other will be described. Only the first grating 104 and the second grating 106 are moved, and the X-ray source 101, the subject platform 113, and the detection unit are fixed.

When a phase image of the subject 103 is obtained using an X-ray Talbot interferometer, there are two types of alignment, namely “alignment for determining the references” and “alignment for correcting deviation from the references”. Here, the “references” refer to a spatial position and an attitude of each component that are suitable to image the subject 103. Even when only either of the two types of alignment is performed, it may be said that “alignment is performed”. In addition, even when only either the spatial position or the attitude of each component is changed, it may be said that “alignment is performed”. In this embodiment, by performing the alignment for correcting deviation from the references during the imaging of the subject 103, deviation of each component generated during the imaging may be reduced, and accordingly changes in the position and the period of the moiré fringe formed on the first detector 108 may be reduced. Methods for performing the two types of alignment will be described more specifically.

In the “alignment for determining the references”, the first detector 108 is used. First, the position and the attitude of the second grating 106 are adjusted while detecting the number of X-rays that have passed through the second grating 106, and a position and an attitude at which the number of X-rays becomes largest are determined as references for the second grating 106. The position of the second grating 106 adjusted here is positions (x₂, y₂) along an x-axis and a y-axis illustrated in FIG. 1, and the attitude of the second grating 106 is an angle (θx₂) relative to the x-axis and an angle (θy₂) relative to the y-axis. Among the references determined here, the position along the x-axis is denoted by x₂₀, the position along the y-axis is denoted by y₂₀, the angle relative to the x-axis is denoted by θx₂₀, and the angle relative to the y-axis is denoted by θy₂₀.

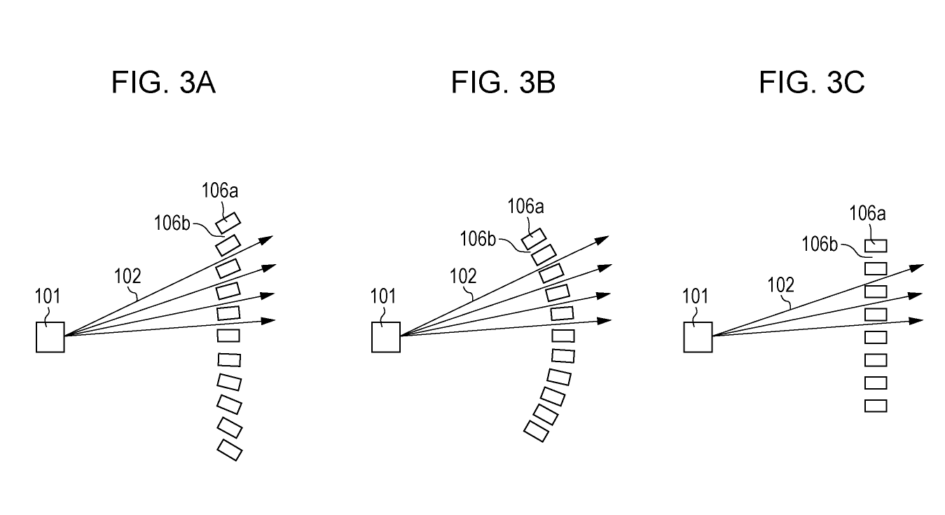

The positions and the angles that serve as the references are recorded on the memory 209 of the calculators, and the second grating 106 is disposed in accordance with the references. The reason why the positions and the angles at which the number of x-rays that have passed through the second grating 106 becomes largest are used as the references is that the X-rays that have passed through the subject 103 may efficiently enter the first detector 108. When the second grating 106 has a curved or focusing structure as illustrated in FIGS. 3A and 3B, however, the position of the second grating 106 needs to be adjusted, but when the second grating 106 has a parallel structure as illustrated in FIG. 3C, only the angles (θx₂, θy₂) of the second grating 106 need to be adjusted. That is, when the second grating 106 has a parallel structure, the positions x₂₀ and y₂₀ need not be determined. In addition, depending on the number of X-rays, the references for the second grating 106 need not necessarily be the positions and the angles at which the number of X-rays that have passed through the second grating 106 becomes largest.

Next, the first grating 104 is provided between the X-ray source 101 and the second grating 106. When an X-ray Talbot interferometer is adopted, the distance between the X-ray source 101 and the first grating 104 and the distance between the first grating 104 and the second grating 106 need to be adjusted such that Talbot interference occurs, but an error of 1 cm or less is allowed in this stage. The X-rays 102 that have passed through the first grating 104 form a moiré fringe along with the second grating 106. In order to adjust the period of the moiré fringe, the relative positions and the relative angles of the first grating 104 and the second grating 106 are adjusted and the references are determined. The relative angles may be adjusted by adjusting the attitudes of the first grating 104 and the second grating 106. The attitude of the first grating 104 adjusted here is angles (θx₁, θy₁, θz₁) between the x-axis, the y-axis, and a z-axis and the first grating 104. The attitude of the second grating 106 is an angle (θz₁) relative to the z-axis, and the relative positions of the first grating 104 and the second grating 106 are positions relative to the z-axis (optical axis) (distance between the first grating 104 and the second grating 106). Among the references determined here, the angles between the first grating and the x-axis, the y-axis, and the z-axis are denoted by θx₁₀, θy₁₀, and θz₁₀, respectively, the angle between the second grating 106 and the z-axis is denoted by θz₂₀, the position of the first grating 104 along the z-axis is denoted by z₁₀, and the position of the second grating 106 along the z-axis is denoted by z₂₀.

These reference positions and angles are recorded on the memory 209, and the first grating 104 and the second grating 106 are disposed in accordance with the references.

Next, the positions of the centers of gravity (hereinafter referred to as reference positions of the centers of gravity) of the alignment marks 105 and 107 when the first grating 104 and the second grating 106 have been disposed in accordance with the references are recorded on the memory 209. The positions of the centers of gravity of the alignment marks 105 and 107 are obtained from results of detection performed by the second to fourth detectors 109 to 111 that detect the X-rays that have passed through the alignment marks 105 and 107.

Here, a method for calculating the positions of the centers of gravity of the alignment marks 105 will be described while taking the alignment marks 105 having spherical shapes illustrated in FIG. 4 as an example.

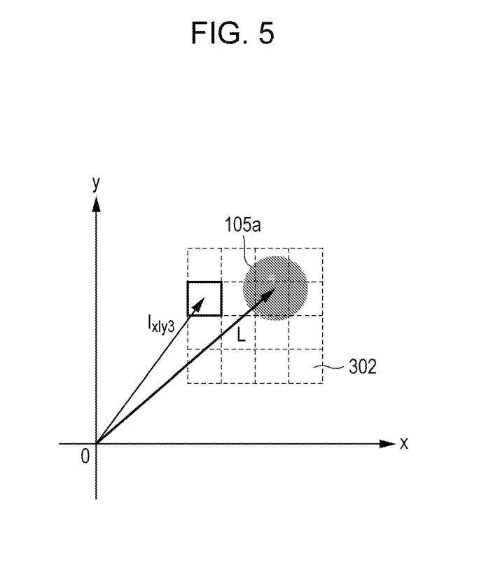

Under a condition that a line connecting the X-ray source 101 and the center of the first detector 108 substantially match the center of the first grating 104, the X-rays that have passed through the alignment marks 105 are detected by the second to fourth detectors 109 to 111, which are independent of one another. The position of the center of gravity of the alignment mark 105a is calculated by performing a moment analysis on the alignment mark 105a using a result of detection performed by the second detector 109, which detects the X-rays that have passed through the alignment mark 105a. FIG. 5 illustrates an example of the moment analysis. In FIG. 5, a method for detecting the position of the center of gravity of the alignment mark 105a read from a detector having four-by-four pixels will be described in order to simplify the description. As represented by an expression (1), the position of the center of gravity may be obtained on the basis of the sum of products of the coordinates (1) of the pixels and the intensity (f) of X-rays detected by the pixels, which equals to a product of the position of the center of gravity (La₀) and the intensity (F) of the entirety of the detector.

La₀×F=111×f11+112×f12+ . . . +144×f44=Σ1×f (1)

Positions of the centers of gravity Lb₀ and Lc₀ of the alignment marks 105b and 105c, respectively, may be obtained from the expression (1) in the same manner. As with the alignment marks 105, the positions of the centers of gravity of the alignment marks 107 may be obtained by performing moment analyses on the alignment marks 107.

In this embodiment, the second detector 109 detects the intensity of X-rays that have passed through the alignment mark 105a and the alignment mark 107a. Therefore, in order to obtain information regarding the center of gravity of the first alignment mark 105a and information regarding the center of gravity of the second alignment mark 107a from changes in results of detection performed by the second detector 109, measures to avoid mixing of these pieces of information regarding the alignment marks 105a and 107a as much as possible needs to be taken.

For example, the patterns of the first alignment mark 105a and the second alignment mark 107a are made sufficiently small relative to a detection range of the second detector 109. Furthermore, a position onto which the first alignment mark 105a is projected and a position onto which the second alignment mark 107a is projected in the detection range of the second detector 109 are made sufficiently distant from each other. In addition, for example, by performing a moment analysis after filtering the results of detection performed by the second detector 109 using a Gaussian function, a Hann function, or the like, it is possible to avoid mixing of the pieces of information regarding the alignment mark 105a and the alignment mark 107a.

On the other hand, when the amounts of movement of the alignment marks 105a and 107a are calculated by recognizing the shapes of the alignment marks 105a and 107a instead of using the method in which the centers of gravity are obtained, the shape of the first alignment mark 105a and the shape of the second alignment mark 107a need to be different from each other. Alternatively, the information regarding the first alignment mark 105a and the information regarding the second alignment mark 107a may be obtained from different detectors. In order to do so, a detector that detects X-rays that have passed through the first alignment mark 105a and a detector that detects X-rays that have passed through the second alignment mark 107a may be separately provided.

During the imaging of the subject 103, the “alignment for correcting deviation from the references” is performed. How much the first grating 104 and the second grating 106 are deviated from the references (hereinafter referred to as the amounts of deviation; the amounts of deviation include information regarding the directions of deviation) is calculated from the amounts of movement of the centers of gravity of the alignment marks 105 and 107. As with the “alignment for determining the references”, the amounts of movement of the centers of gravity of the alignment marks 105 and 107 may be calculated by calculating the positions of the centers of gravity of the alignment marks 105 and 107 and comparing the calculated positions of the centers of gravity with the reference positions of the centers of gravity.

First, the amount of deviation of the first grating 104 is calculated.

The amounts of movement of the centers of gravity of the three first alignment marks 105 are each divided into the amount of movement in the x direction and the amount of movement in the y direction, and a total of six amounts of movement are calculated. Here, the amounts of movement of the alignment mark 105a from the references along the x-axis and the y-axis are denoted by dxa and dya, respectively. Similarly, the amounts of movement of the alignment mark 105b from the references along the x-axis and the y-axis are denoted by dxb and dyb, respectively, and the amounts of movement of the alignment mark 105c from the references along the x-axis and the y-axis are denoted by dxc and dyc, respectively.

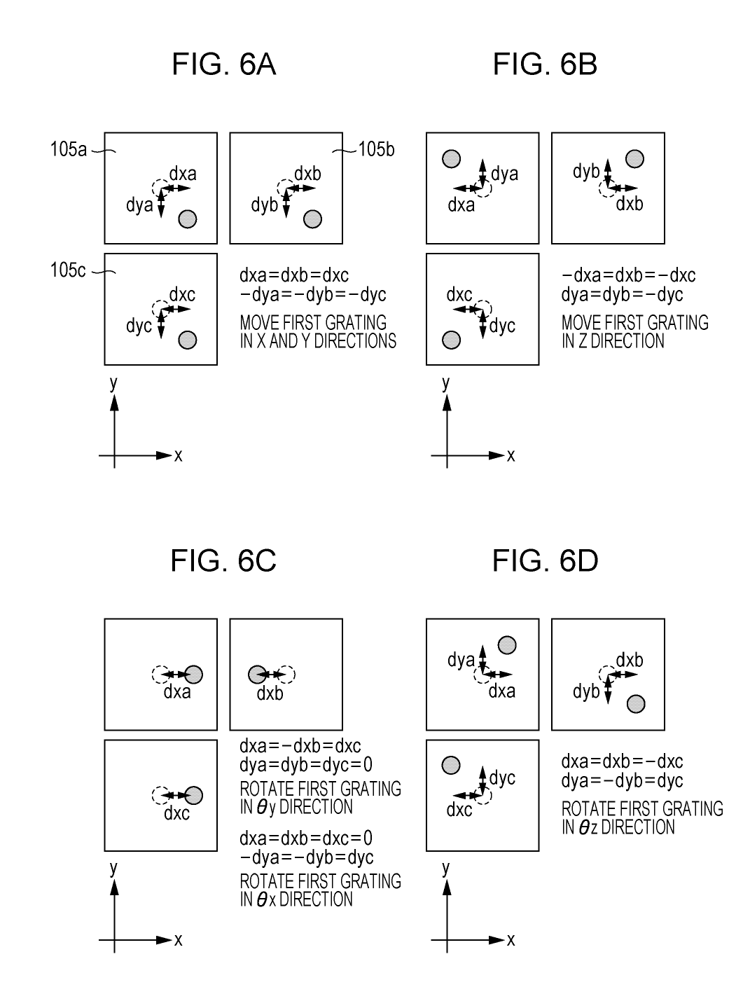

FIGS. 6A to 6D illustrate typical examples of a relationship between the movement distances and the movement directions of the alignment marks 105 and the amount of deviation of the first grating 104. As illustrated in FIG. 6A, when dxa=dxb=dxc and −dya=−dyb=−dyc, the entirety of the first grating 104 has moved in the x direction by dx and in the y direction by −dy. As illustrated in FIG. 6B, when −dxa=dxb=−dxc and dya=dyb=−dyc, the entirety of the first grating 104 has moved toward the X-ray source 101 (the entirety of the first grating 104 has been enlarged). As illustrated in FIG. 6C, when dxa=−dxb=dxc and dya=dyb=dyc=0, the entirety of the first grating 104 has rotated around the y-axis. Similarly, when dxa=dxb=dxc=0 and −dya=−dyb=dyc, the entirety of the first grating 104 has rotated around the x-axis. As illustrated in FIG. 6D, when dxa=dxb=−dxc and dya=−dyb=dyc, the entirety of the first grating 104 has rotated in plane.

The amount of deviation of the second grating 106 may be obtained in the same manner as for the amount of deviation of the first grating 104.

After calculating the amounts of deviation of the first grating 104 and the second grating 106, the amounts of alignment for correcting the deviation are calculated, and the first grating 104 and the second grating 106 are moved in accordance with the amounts of alignment. Thus, the deviation of the first grating 104 and the second grating 106 may be corrected. The amounts of alignment (include information regarding the directions of alignment) of the first grating 104 and the second grating 106 calculated by the calculator 207 on the basis of the amounts of deviation of the first grating 104 and the second grating 106 are transmitted to the movement sections 203 and 204, respectively, by a movement instruction section 206. After moving the first grating 104 and the second grating 106, the centers of gravity of the alignment marks 105 and 107 are calculated again, and the first grating 104 and the second grating 106 are moved again. Thus, by repeating calculation of the amounts of deviation of the first grating 104 and the second grating 106 and movement of the first grating 104 and the second grating 106, the amounts of deviation of the first grating 104 and the second grating 106 may be suppressed. The calculation of the amounts of deviation of the first grating 104 and the second grating 106 and the movement of the first grating 104 and the second grating 106 need not be performed alternately, and the calculation may be performed a plurality of times and then the first grating 104 and the second grating 106 may be moved. The calculation of the amount of deviation of the first grating 104 and the calculation of the amount of deviation of the second grating 106 need not be simultaneously performed, and the movement of the first grating 104 and the second grating 106 need not be simultaneously performed. Alternatively, the calculation of the amount of deviation and the movement of either the first grating 104 or the second grating 106 may be performed while fixing the other grating. The calculators may create and record a table so that the amounts of deviation may be obtained on the basis of the intensity of X-rays in each pixel, and the amounts of deviation may be obtained by referring to the table.

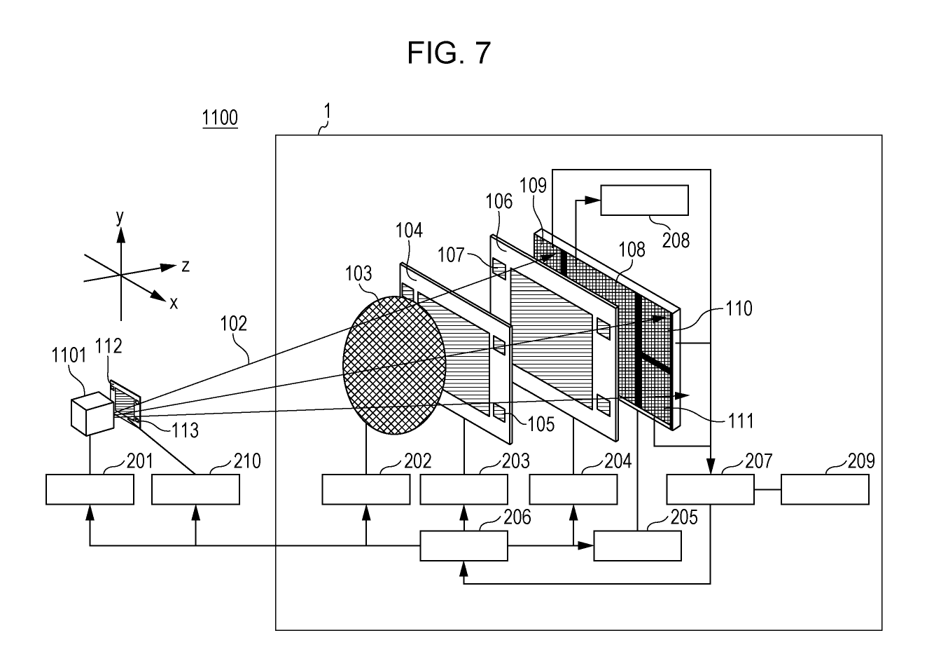

In the X-ray Talbot interferometry, a small light source whose focus size is 20 μm or less is needed in order to improve the coherence of the X-ray source 101. FIG. 1 illustrates a configuration assuming that the focus size of the X-ray source 101 is small, and when the focus size is small, the number of X-rays 102 radiated becomes small and measurement time becomes longer. Therefore, as illustrated in FIG. 7, X-ray Talbot-Lau interferometry may be adopted. In order to adopt the X-ray Talbot-Lau interferometry, an X-ray imaging system 1100 may be configured using an X-ray source 1101 having a large focus size of hundreds of micrometers and a source grating 112. When the X-ray imaging system 1100 includes a movement section 210 that moves the source grating 112, alignment of the source grating 112 may be performed in the same manner as for the first grating 104 and the second grating 106.

When a phase image or a differential phase image is obtained in this embodiment, the positions of the first grating 104 along the x-axis and the y-axis are not important in the “alignment for determining the references”. This is because the phase amount of the subject 103 is not affected by the initial position of the moiré fringe (the position of the moiré fringe before the imaging) regardless of whether a “fringe scanning technique” or a “Fourier transform”, which is a general method for analyzing the phase amount of the subject 103, is selected. However, because it is not desirable that the moiré fringe moves while the subject 103 is being imaged, the positions of the first grating 104 along the x-axis and the y-axis are important in the “alignment for correcting deviation from the references”.

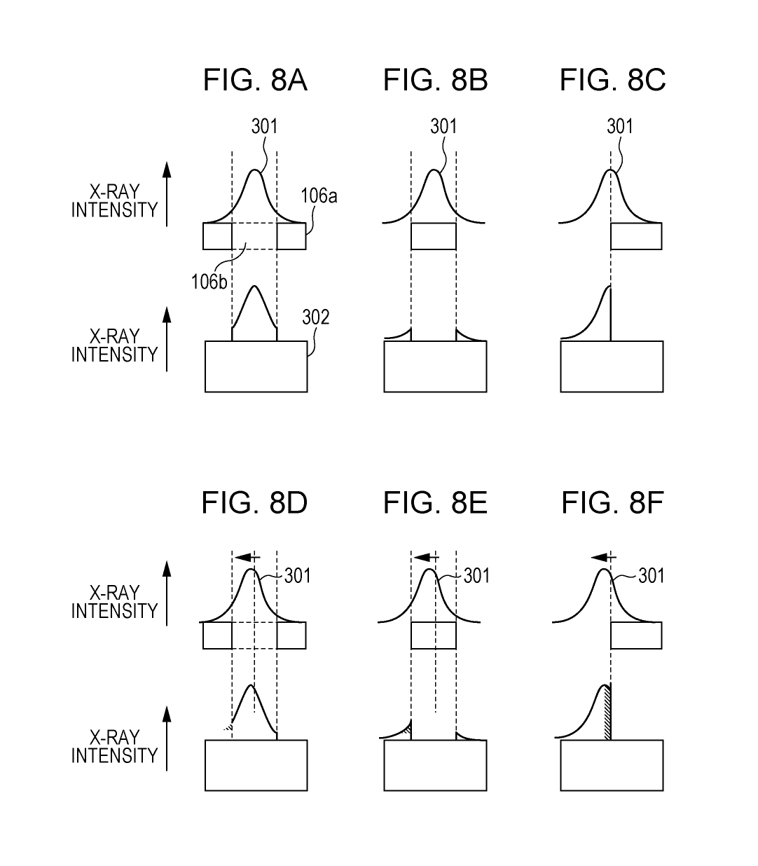

On the other hand, when a bright-field image, a dark-field image, or an intermediate image between the bright-field image and the dark-field image (hereinafter referred to as an “intermediate-field image”) is obtained, the positions of the first grating 104 along the x-axis and the y-axis are important even in the “alignment for determining the references”. The bright-field image, the dark-field image, and the intermediate-field image will be simply described hereinafter with reference to FIGS. 8A to 8F.

FIGS. 8A to 8F illustrate positional relationships between X-ray intensity 301 of the self-image formed on the second grating 106 and a screening portion 106a of the second grating 106 and X-ray intensity 303 of the intensity distribution of X-rays formed in a pixel 302 of the first detector 108 corresponding to each positional relationship. Higher positions of the X-ray intensity 301 of the self-image and the X-ray intensity 303 of the intensity distribution of X-rays in the pixel 302 in FIGS. 8A to 8F indicate higher intensity. FIG. 8A illustrates a positional relationship between the X-ray intensity 301 of the self-image and the screening portion 106a at a time when a “bright-field image” is obtained, and, in the self-image, the highest portion of the X-ray intensity 301 and portions around the highest portion pass through an opening 106b in the second grating 106. FIG. 8B illustrates a positional relationship between the X-ray intensity 301 of the self-image and the screening portion 106a at a time when a “dark-field image” is obtained, and, in the self-image, the lowest portion of the X-ray intensity 301 and portions around the lowest portion pass through the opening 106b in the second grating 106. FIG. 8C illustrates a positional relationship between the X-ray intensity 301 of the self-image and the screening portion 106a at a time when an “intermediate-field image” is obtained, and, in the self-image, the highest portion of the X-ray intensity 301 is located at a boundary between the screening portion 106a and the opening 106b of the second grating 106. In FIGS. 8A to 8F, in order to simplify the concepts of the “bright-field image”, the “dark-field image”, and the “intermediate-field image”, it is assumed that one opening 106b in the second grating 106 and one pixel 302 of the first detector 108 are provided for each bright portion (portion in which the X-ray intensity 301 is high) of the self-image. In a general X-ray Talbot interferometer, a plurality of bright portions of the self-image and a plurality of openings 106b in the second grating 106 are provided for each pixel of the first detector 108.

It is difficult to separately obtain information regarding absorption, refraction, and scattering of X-rays caused by the subject 103 from the bright-field image, the dark-field image, or the intermediate-filed image, but there are advantages that scanning is not necessary unlike the fringe scanning technique and an image may be obtained through simpler calculation than in the Fourier transform.

When a bright-field image is obtained, as illustrated in FIG. 8A, the highest portion of the X-ray intensity 301 of the self-image passes through the opening 106b in the second grating 106 and enters the first detector 108. Therefore, the self-image passes through the second grating 106 in a state in which the self-image has been attenuated in accordance with the absorptance of the subject 103. If refraction and scattering caused by the subject 103 are zero, 100% of information that enters the pixel 302 of the first detector 108 depends on the absorptance of the subject 103. As illustrated in FIG. 8D, however, if X-rays are refracted by the subject 103, the X-ray intensity 301 of the self-image moves on the second grating 106, and accordingly the intensity of X-rays that pass through the second grating 106 decreases by a hatched portion. Therefore, even with the subject 103 having the same absorptance, the intensity of X-rays that enter the pixel 302 of the first detector 108 is different if the index of refraction is different. In addition, the same phenomenon occurs when X-rays are scattered by the subject 103, and as the degree of scattering becomes higher, the intensity of X-rays that pass through the second grating 106 becomes lower.

When a dark-field image is obtained, as illustrated in FIG. 8B, the lowest portion of the X-ray intensity 301 of the self-image passes through the opening 106b in the second grating 106 and enters the first detector 108. As illustrated in FIG. 8E, since the X-ray intensity 301 of the self-image moves on the second grating 106, the intensity of X-rays that pass through the second grating 106 increases by a hatched portion. That is, in the case of the dark-field image, in contrast to the case of the bright-field image, the intensity of X-rays that pass through the second grating 106 increases as refraction and scattering caused by the subject 103 become larger. Other basic concepts are the same as those in the case of the bright-field image. Because the percentage of an absorption component of the subject 103 in the case of the dark-field image is lower than that in the case of the bright-field image, the dark-field image is more susceptible to refraction and scattering caused by the subject 103 than the bright-field image.

The intermediate-field image is an intermediate concept between the bright-field image and the dark-field image. As illustrated in FIG. 8F, since the X-ray intensity 301 of the self-image moves on the second grating 106, the intensity of X-rays that pass through the second grating 106 increases by a hatched portion. As may be seen from FIGS. 8D to 8F, the size of the hatched portion illustrated in FIG. 8F is the largest, which means that the amount of change in the intensity of X-rays caused by refraction and scattering caused by the subject 103 in the case of the intermediate-field image is larger than in the cases of the bright-field image and the dark-field image.

The bright-field image, the dark-field image, and the intermediate-field image are images obtained using an imaging method for which the positional relationship between the self-image and the screening portion 106a of the second grating 106 is important. Therefore, this imaging method is different from a method for obtaining a phase image (differential phase image) in that the positions of the first grating 104 and the second grating 106 along the x-axis and the y-axis are important in the “alignment for determining the references”, but with respect to other aspects, this method is the same as that used in the alignment for obtaining a phase image.

The “alignment for determining the references” when at least any of a bright-field image, a dark-field image, and an intermediate-field image is obtained will be described. First, as in the case in which a phase image is obtained, the references for the second grating 106 and the first grating 104 are determined. When a bright-field image, a dark-field image, or an intermediate-field image is obtained, however, a moiré fringe need not be generated, which is different from the case in which a phase image is obtained. That said, even if a moiré fringe has been generated, the moiré fringe may be removed through a calculation process performed by the calculator 208 after imaging data regarding the subject 103 is obtained.

Next, the reference positions of the first grating 104 along the x-axis and the y-axis are determined. The reference position along the x-axis is determined by moving the first grating 104 in the x direction illustrated in FIG. 1 and obtaining a movement distance and an integrated value of the intensity of X-rays detected by the first detector 108. The position of the first grating 104 at which the integrated value of the X-ray intensity becomes largest is determined as the reference position along the x-axis for obtaining a bright-field image, and the position of the first grating 104 at which the integrated value of the X-ray intensity becomes smallest is determined as the reference position along the x-axis for obtaining a dark-field image. The position of the first grating 104 at which the integrated value of the X-ray intensity becomes an intermediate value obtained by subtracting the smallest value from the largest value is determined as the reference position along the x-axis for obtaining an intermediate-field image. However, the reference position when an intermediate-field image is obtained may be a position other than the positions of the first grating 104 at times when a bright-field image and a dark-field image are obtained. The reference position of the first grating 104 along the y-axis may be determined in the same manner.

The source grating 112 may also be used when a bright-field image, a dark-field image, or an intermediate-field image is obtained. When the source grating 112 is used, alignment of the source grating 112 may be performed using results of detection performed by the second detector 109, but because a method for determining the reference positions of the source grating 112 along the x-axis and the y-axis is partly different from that used when a phase image is obtained, the method will be described hereinafter. When the source grating 112 is used, the position of the self-image on the second grating 106 moves depending on the relative positions of the first grating 104 and the source grating 112. Therefore, when a bright-field image, a dark-field image, or an intermediate-field image is obtained, the reference positions along the x-axis and the y-axis may be determined by moving only either the first grating 104 or the source grating 112. The method for determining the reference positions is the same as that used when the source grating 112 is not introduced, that is, the positions of the first grating 104 and the source grating 112 at which the integrated value of the X-ray intensity becomes largest are determined as the reference positions for obtaining a bright-field image. Similarly, the positions of the first grating 104 and the source grating 112 at which the integrated value of the X-ray intensity becomes smallest are determined as the reference positions for obtaining a dark-field image. The positions of the first grating 104 and the source grating 112 at which the integrated value of the X-ray intensity becomes an intermediate value obtained by subtracting the smallest value from the largest value are determined as the reference positions for obtaining an intermediate-field image. Alternatively, as in the case in which the source grating 112 is not used, an image obtained when the relative positions of the first grating 104 and the source grating 112 are other than the relative positions of the first grating 104 and the source grating 112 at times when a bright-field image and a dark-field image are obtained may be determined as an intermediate-field image.

When the source grating 112 is introduced, it is important to keep the relative positions of the source grating 112 and the first grating 104 at the reference positions, and therefore both the positions of the first grating 104 and the source grating 112 may be adjusted, or either the position of the first grating 104 or the position of the source grating 112 may be adjusted. Alternatively, for example, the position along the x-axis may be adjusted using the diffraction grating 104 and the position along the y-axis may be adjusted using the source grating 112. Alternatively, instead of adjusting the relative positions of the source grating 112 and the first grating 104 along the x-axis and the y-axis, the positions of the second grating 106 along the x-axis and the y-axis may be adjusted. However, the effect of reducing the exposure dose of the subject 103 is larger when the relative positions of the source grating 112 and the first grating 104 along the x-axis and the y-axis are adjusted.

In this embodiment, it is assumed that the patterns of the first grating 104 and the second grating 106 are two-dimensional. However, when the patterns of the first grating 104 and the second grating 106 are one-dimensional as illustrated in FIG. 4, alignment may be performed only in a direction (x direction in FIG. 4) in which the periods of the patterns are formed.

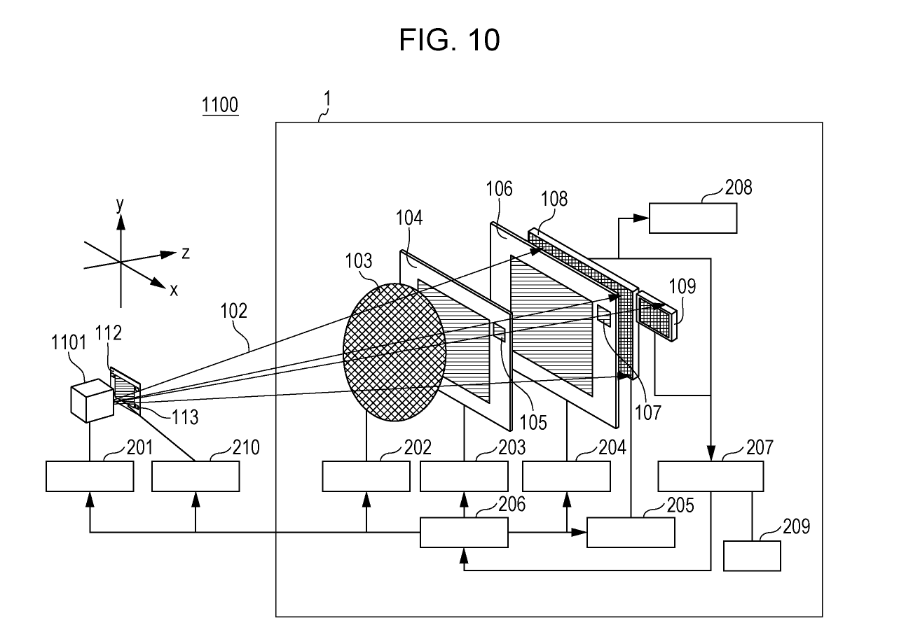

Although only one sphere is set for each alignment mark in this embodiment, a plurality of spheres may be set for each alignment mark as illustrated in FIG. 9A. By analyzing the amounts of movement of a plurality of alignment marks, noise tolerance improves and the accuracy of the amount of movement and the movement direction of the grating increases. When the three alignment marks 105a to 105c are provided away from one another, the third detector 110 and the fourth detector 111 are necessary in order to obtain the patterns of these alignment marks 105a to 105c. Therefore, as illustrated in FIG. 10, the three alignment marks 105a to 105c may be provided close to one another and measurement may be performed only by the second detector 109. When a plurality of alignment marks are analyzed by a single detector, however, measures to avoid mixing of information regarding the individual alignment marks as much as possible need to be taken. As such measures, the same measures as those to avoid mixing of information regarding the first alignment marks 105a to 105c of the first grating 104 and information regarding the second alignment marks 107a to 107c of the second grating 106 may be taken. For example, a certain alignment mark in obtained two-dimensional intensity information is filtered using a Gaussian function, a Hann function, or the like, and then subjected to a moment analysis.

The “alignment for determining the references” may be performed when the X-ray imaging apparatus 1 is activated or when the X-ray imaging apparatus 1 is reactivated after a problem occurs, and in a normal state, it might be enough to perform only the “alignment for correcting deviation from the references”.

Although the first to fourth detectors 108 to 111 are moved by the single movement section 205, a movement section may be provided for each of the first to fourth detectors 108 to 111, and the first to fourth detectors 108 to 111 may be moved independently of one another.

In this embodiment, when the subject 103 enters the detection ranges of the second to fourth detectors 109 to 111 in the “alignment for correcting deviation from the references”, it becomes difficult to distinguish a change in results of detection caused by refraction of X-rays due to the subject 103 and a change in results of detection caused by movement of each grating. Therefore, the subject 103 may be kept from entering the detection ranges of the second to fourth detectors 109 to 111 or the “alignment for determining the references” may be performed after disposing the subject 103 in the X-ray imaging apparatus 1.

In this embodiment, the pixel sizes of the first to fourth detectors 108 to 111 need not be the same. In addition, the exposure times of the second to fourth detectors 109 to 111 according to this embodiment need not be the same, and even if the exposure times are the same, the timing of exposure may be different.

Although Talbot interferometry is used as a method for imaging the subject 103, the method for imaging the subject 103 is not limited to the Talbot interferometry, and other types of interferometry or a method in which an interferometer is not used may be used, instead.

### Second Embodiment

An X-ray imaging apparatus according to this embodiment is different from the X-ray imaging apparatus 1 according to the first embodiment in that the X-ray imaging apparatus according to this embodiment includes a fifth detector 114 and gratings (hereinafter referred to as alignment patterns) having periodic structures as alignment marks. Other components are the same as those according to the first embodiment.

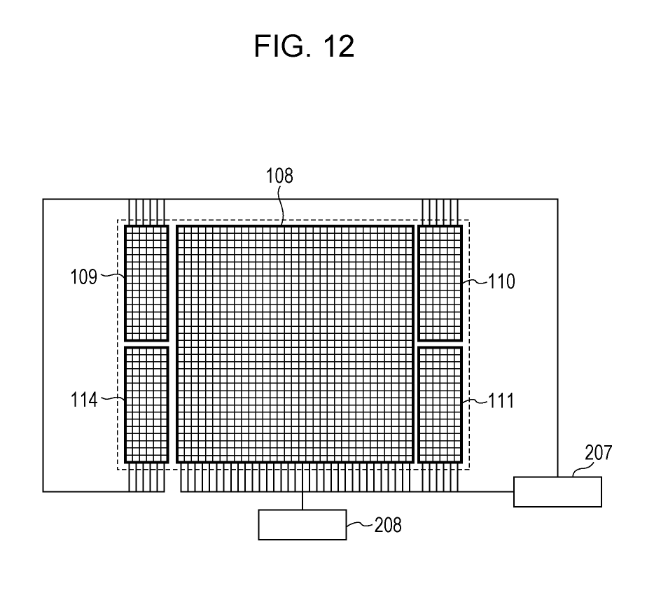

As illustrated in FIG. 12, the X-ray imaging apparatus according to this embodiment includes the fifth detector 114 under the second detector 109, and the second to fifth detectors 109 to 114 perform detection for realizing alignment.

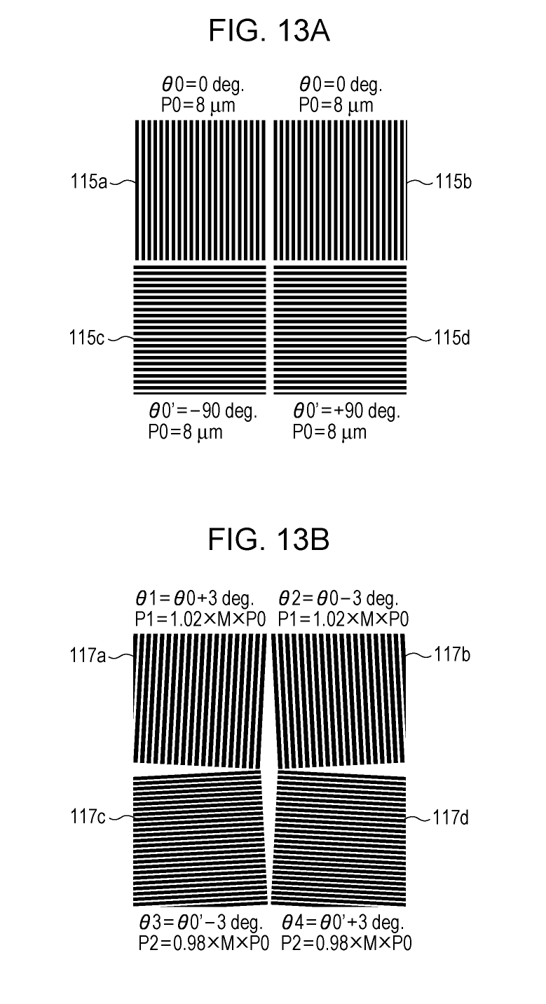

In this embodiment, diffraction gratings are used as the alignment patterns of the first grating 104 and absorption gratings are used as the alignment patterns of the second grating 106. Moiré fringes are formed by overlapping the corresponding alignment patterns. The alignment is performed by detecting the moiré fringes using the second to fifth detectors 109 to 114. Therefore, the alignment patterns may be formed in the same planes as the gratings. FIG. 13A illustrates an example of alignment patterns 115 of the first grating 104 used in this embodiment, and FIG. 13B illustrates an example of alignment patterns 117 of the second grating 106 used in this embodiment.

The alignment patterns 115 of the first grating 104 may be phase gratings that modulate only the phases of X-rays while maintaining intensity information regarding the intensity of X-rays, and accordingly the alignment patterns 115 may be composed of a material whose X-ray absorptance is small such as C, Si, or Al. However, amplitude diffraction gratings may be used, instead. On the other hand, since the alignment patterns 117 of the second grating 106 need to propagate part of information regarding the X-rays while screening the rest of the information, the alignment patterns 117 may be composed of a material whose X-ray absorptance is large such as Pb or Au.

Because a Talbot phenomenon is used to image the subject 103 in this embodiment, the periods and the amounts of phase modulation of the first grating 104 and the alignment patterns 115 of the first grating 104 may be the same. When the periods and the amounts of phase modulation are the same, the alignment becomes easier because a Talbot distance for imaging the subject 103 and a Talbot distance for performing the alignment become the same. In this embodiment, the amounts of phase modulation of the first grating 104 and the alignment patterns 115 of the first grating 104 are a quarter of the wavelength of effective energy in the case of white X-rays and a quarter of a Kα1 wavelength in the case of characteristic X-rays. The alignment patterns 115 of the first grating 104 are stripes, and the ratio of portions that perform phase modulation to portions that do not perform phase modulation is 1:1. The alignment patterns 117 of the second grating 106 are also stripes, and a ratio of portions that propagate X-rays to portions that screen X-rays is 1:1. As illustrated in FIGS. 13A and 13B, four alignment patterns 115a to 115d of the alignment patterns 115 of the first grating 104 are formed such that the same period (P0) and two rotation angles (θ0 and θ0′) are obtained. On the other hand, four alignment patterns 117a to 117d of the alignment patterns 117 of the second grating 106 are formed such that periods P1 and P2 and four rotation angles (θ1, θ2, θ3, and θ4) are obtained. A rotation angle refers to an angle between the direction of the period of the self-image and the direction of the period of an alignment pattern.

The directions of the periods of the alignment patterns 115a and 115b of the first grating 104 are formed in such a way as to match the direction of the period of the first grating 104 (rotation angle θ0=0). The directions of the periods of the alignment patterns 115c and 115d of the first grating are formed in such a way as to be perpendicular to the direction of the period of the first grating 104 (θ0′=90).

The alignment pattern 117a of the second grating 1θ6 illustrated in FIG. 13B has a period (P1) obtained by multiplying the period (P0) of the alignment pattern 115a of the first grating 104 by M and then multiplying the resultant period by 1.02. In addition, the alignment pattern 117a of the second grating 106 is formed such that a difference (hereinafter simply referred to as a “difference between the rotation angles”) between the rotation angle of the alignment pattern 115a of the first grating 1θ4 and the rotation angle of the alignment pattern 117a of the second grating 1θ6 becomes 3 degrees. Here, however, the following expression applies.

M=(L1+L2)/L1

L1: Distance between the X-ray source 101 and the first grating 104
L2: Distance between the first grating 104 and the second grating 106
The alignment pattern 117b of the second grating 106 has a period (P1) obtained by multiplying the period (P0) of the alignment pattern 115b of the second grating 106 by M and then multiplying the resultant period by 1.02, and is formed such that the difference between the rotation angles becomes 3 degrees.

The alignment pattern 117c of the second grating 106 has a period (P2) obtained by multiplying the period (P0) of the alignment pattern 115c of the first grating 104 by M and then multiplying the resultant period by 0.98, and is formed such that the difference between the rotation angles becomes 3 degrees. The alignment pattern 117d of the second grating 106 has a period (P2) obtained by multiplying the period of the alignment pattern 115d of the first grating 104 by M and then multiplying the resultant period by 0.98, and is formed such that the difference between the rotation angles becomes 3 degrees. Although P1=P0×M×1.02 and P2=P0×M×0.98 here, P1 and P2 are not limited to these values. P1 may be longer than the period obtained by multiplying the period (P0) of the alignment pattern 115a of the first grating 104 by M by several percent, and P2 may be shorter than the period obtained by multiplying the period (P0) of the alignment pattern 115a of the first grating 104 by M by several percent. In addition, the differences between the rotation angles are not limited to 3 degrees and −3 degrees, and may be set in accordance with moiré fringes to be generated. When the first grating 104 and the second grating 106 are disposed at the reference points, however, the periods of the alignment patterns 115 (115a to 115d) of the first grating 104 and the periods of the patterns formed on the alignment patterns 117 of the second grating 106 may match. Similarly, the periods of the alignment patterns 117 (117a to 117d) of the second grating 106 and the periods of the four moiré fringes formed on the second to fifth detectors 109 to 114, respectively, may match. Therefore, when P1 is longer than the period obtained by multiplying the period (P0) of the alignment pattern 115a of the first grating 104 by M by x %, P2 may be shorter than the period by x %. The absolute values of the differences between the rotation angles may be the same.

An example of an alignment method used by an X-ray imaging system according to this embodiment will be described.

The first grating 104 and the second grating 106 whose alignment patterns are formed in the same planes are disposed between the X-ray source 101 and the first to fifth detectors 108 to 114. The first grating 104 is disposed close to the X-ray source 101 compared to the second grating 106. In the X-ray Talbot interferometry, the distance between the X-ray source 101 and the first grating 104 and the distance between the first grating 104 and the second grating 106 need to be set such that Talbot interference occurs, but an error of 1 cm or less is allowed in this stage. After disposing the gratings 104 and 106, the references y₂₀, x₂₀, θx₂₀, and θy₂₀ for the second grating 106 are determined.

X-rays that have passed through the alignment patterns 117 of the second grating 106 are detected by the second to fifth detectors 109 to 114, and integrated intensity or an average of intensity in a unit area is obtained. This procedure is repeated a plurality of times while changing the positions y₂ and x₂ and the angles θx₂ and θy₂ of the second grating 106, and the positions and the angles of the second grating 106 at which the X-ray intensity is largest are determined as the references (y₂₀, x₂₀, θx₂₀, and θy₂₀). The references are recorded on the memory 209, and the second grating 106 is disposed in accordance with the references. As in the first embodiment, however, the reference x₂₀ is used in alignment at a time when the second grating 106 has a curved or focusing structure as illustrated in FIGS. 3A and 3B, and therefore need not necessarily be used when the second grating 106 has a parallel structure as illustrated in FIG. 3C. When the references y₂₀, x₂₀, θx₂₀, and θy₂₀ are determined, only one of the second to fifth detectors 109 to 114 may be used, a plurality of detectors may be used, or all the detectors 109 to 114 may be used. Alternatively, the references y₂₀, x₂₀, θx₂₀, and θy₂₀ for the second grating 106 may be determined using the first detector 108.

Next, the reference points θx₁₀ and θy₁₀ for the first grating 104 are obtained using the patterns formed by the alignment patterns 115 of the first grating 104 on the alignment patterns 117 of the second grating 106 and the moiré fringes formed by the alignment patterns 117.

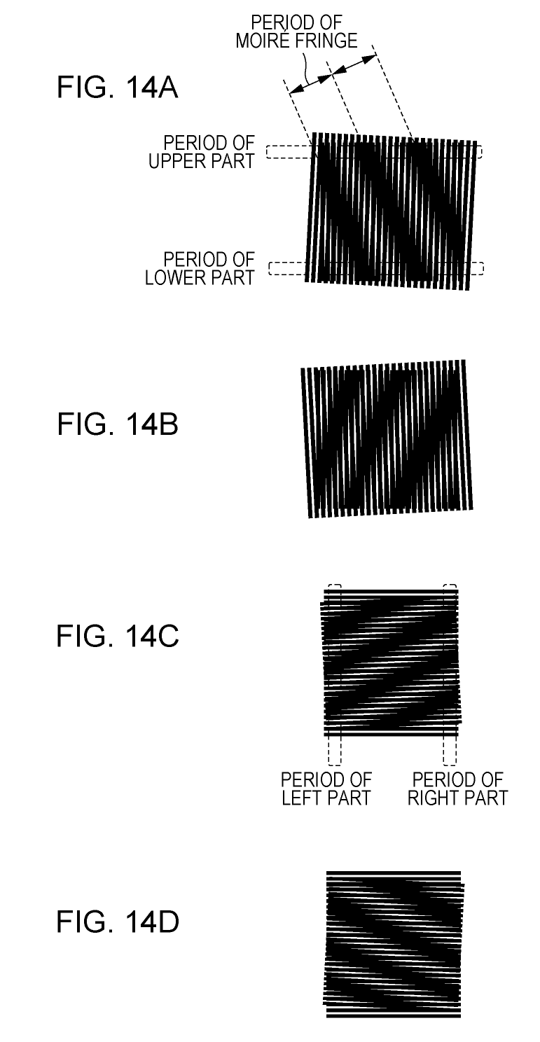

FIG. 14A illustrates a moiré fringe formed by the alignment pattern 115a of the first grating 104 and the alignment pattern 117a of the second grating 106. FIG. 14B illustrates a moiré fringe formed by the alignment pattern 115b of the first grating 104 and the alignment pattern 117b of the second grating 106. FIG. 14C illustrates a moiré fringe formed by the alignment pattern 115c of the first grating 104 and the alignment pattern 117c of the second grating 106. FIG. 14D illustrates a moiré fringe formed by the alignment pattern 115d of the first grating 104 and the alignment pattern 117d of the second grating 106.

The reference point θx₁₀ of the first grating 104 is an angle at which the periods of upper and lower parts of the moiré fringe illustrated in FIG. 14A match. However, the periods of the upper and lower parts of the moiré fringe refer to the periods of the upper and lower parts of the moiré fringe in the x direction. The upper and lower parts need not necessarily be upper and lower ends, but a distance between the upper and lower parts in a direction perpendicular to the x direction may be as large as possible. If the upper part of the first grating 104 is inclined to the second grating 106 (the reference point θx₁ has been rotated), the period of the lower part of the moiré fringe formed by the alignment pattern 117a of the second grating 106 becomes longer than the period of the upper part of the moiré fringe. This is because a difference in the enlargement ratio is generated between the upper and lower parts of the alignment pattern 115a of the first grating 104 when the first grating 104 deviates from the reference point θx₁₀. Similarly, the reference point θx₁₀ may be obtained using the moiré fringe formed by the alignment pattern 117b of the second grating 106.

Similarly, as illustrated in FIG. 14C, the reference point θy₁₀ of the first grating 104 is an angle at which the periods of left and right parts of the moiré fringe match. However, the periods of the left and right parts of the moiré fringe refer to the periods of the left and right parts of the moiré fringe in the y direction. The left and right parts need not necessarily be left and right end, but a distance between the left and right parts in a direction perpendicular to the y direction may be as large as possible. The reference points θx₁₀ and θy₁₀ for the first grating 104 are recorded on the calculator 207, and the first grating 104 is disposed at the reference points θx₁₀ and θy₁₀.

Next, the reference point θz₁₀ of the first grating 104 and the reference point θz₂₀ of the second grating 106 are obtained using the moiré fringes formed by the alignment patterns 115a and 115b of the first grating 104 and the alignment patterns 117a and 117b of the second grating 106.

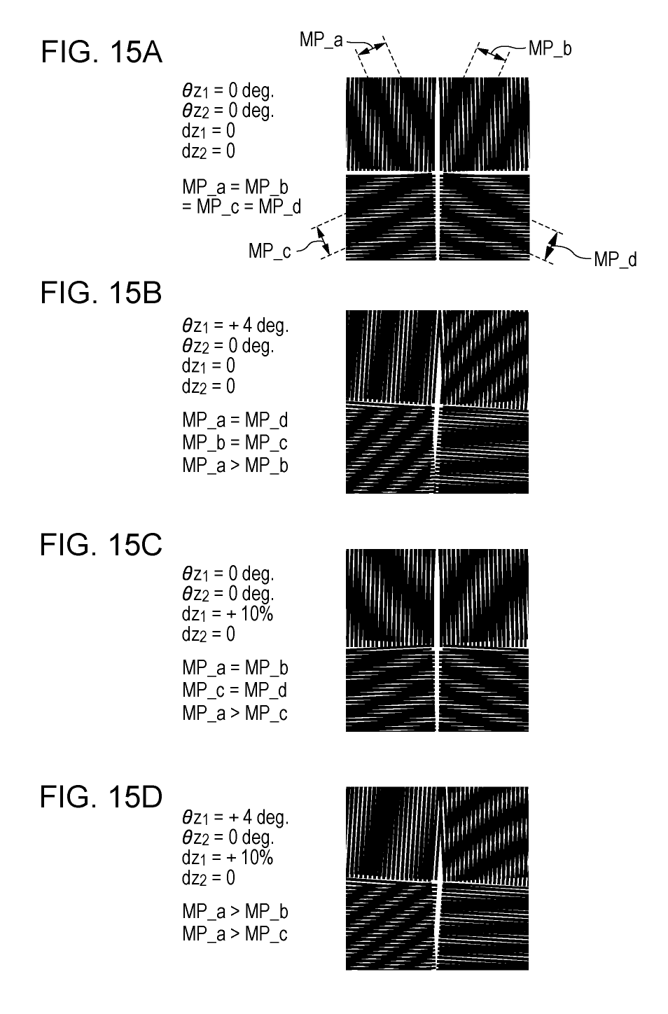

An upper-left part of FIG. 15A illustrates a moiré fringe (period MP_a) formed by the alignment pattern 115a of the first grating 104 and the alignment pattern 117a of the second grating 106. An upper-right part of FIG. 15A illustrates a moiré fringe (period MP_b) formed by the alignment pattern 115b of the first grating 104 and the alignment pattern 117b of the second grating 106. A lower-left part of FIG. 15A illustrates a moiré fringe (period MP_c) formed by the alignment pattern 115c of the first grating 104 and the alignment pattern 117c of the second grating 106. A lower-right part of FIG. 15A illustrates a moiré fringe (period MP_d) formed by the alignment pattern 115d of the first grating 104 and the alignment pattern 117d of the second grating 106. FIG. 15B illustrates moiré fringes at a time when an angle (θz₁) between the first grating 104 and the z-axis has been rotated (deviated from the reference point θz₁₀) clockwise from the state illustrated in FIG. 15A by 4 degrees. FIG. 15C illustrates moiré fringes at a time when the first grating 104 has moved from the state illustrated in FIG. 15A toward the X-ray source 101 (deviated from the reference point z₁₀) along the z-axis. FIG. 15D illustrates moiré fringes at a time when an angle between the first grating 104 and the z-axis has been rotated clockwise from the state illustrated in FIG. 15A by 4 degrees and the first grating 104 has moved toward the X-ray source 101 along the z-axis.

As illustrated in FIG. 15A, angles at which the periods of the moiré fringe formed by X-rays that have passed through the alignment pattern 117a of the second grating 106 and the moiré fringe formed by X-rays that have passed through the alignment mark 117b match are determined as the reference point θz₁₀ for the first grating 104 and the reference point θz₂₀ for the second grating 106, and the reference points θz₁₀ and θz₂₀ are recorded on the memory 209.

As illustrated in FIG. 15B, when the period of the moiré fringe formed by the alignment pattern 117b of the second grating 106 is shorter than the period of the moiré fringe formed by the alignment pattern 117a of the second grating 106, alignment to the references may be realized by rotating the angle θz₁ of the first grating 104 counterclockwise. Similarly, when the period of the moiré fringe formed by X-rays that have passed through the alignment mark 117b of the second grating 106 is longer than the period of the moiré fringe formed by X-rays that have passed through the alignment pattern 117a of the second grating 106, alignment may be realized by rotating the angle θz₁ of the first grating 104 clockwise. The same result may be obtained using a combination between the moiré fringe formed by X-rays that have passed through the alignment pattern 117c of the second grating 106 and the moiré fringe formed by X-rays that have passed through an alignment mark 117d of the second grating 106.

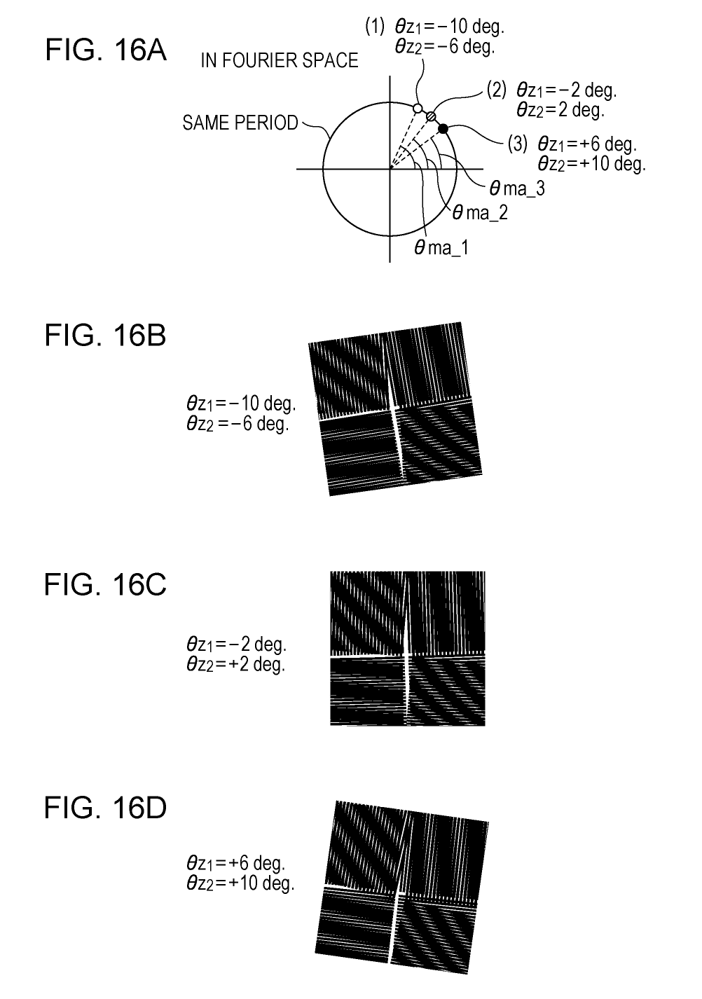

When the “alignment for correcting deviation from the references” is performed, however, it is difficult, only on the basis of an analysis of the periods of the moiré fringes, to identify which of the first grating 104 and the second grating 106 has rotated. Therefore, by performing Fourier transforms on the moiré fringes detected by the second to fifth detectors 109 to 114 to analyze not only the periods of the moiré fringes but also the directions (period directions) of the fringes, the amount of rotation of each grating may be obtained. FIG. 16A illustrates a Fourier space obtained by performing the Fourier transforms on the moiré fringes. Three coordinates (1) to (3) illustrated in FIG. 16A indicate peak positions obtained by performing Fourier transforms on the moiré fringes formed when the first grating 104 and the second grating 106 are under the following three conditions (1) to (3), respectively, relative to the above-described references (θx₁₀, θz₁₀).

(1) The first grating 104 has been rotated clockwise by −10 degrees and the second grating 106 has been rotated clockwise by −6 degrees
(2) The first grating 104 has been rotated clockwise by −2 degrees and the second grating 106 has been rotated clockwise by 2 degrees
(3) The first grating 104 has been rotated clockwise by 6 degrees and the second grating 106 has been rotated clockwise by 10 degrees

Although the rotation angles and the rotation directions of each grating under the above-described three conditions are different from one another, the periods of the generated moiré fringes are the same because differences between the rotation angles of the first grating 104 and the second grating 106 are the same, that is, 4 degrees (distributed along a concentric circle in the Fourier space illustrated in FIG. 16A). However, as illustrated in FIG. 16A, since the angles at which the moiré fringes are generated are different, the peak positions of the three moiré fringes do not overlap. The rotation angles at which the moiré fringes are generated may be obtained from the Fourier space. The angle θz₁ of the first grating 104 and the angle θz₂ of the second grating 106 may be obtained from an analysis of a single alignment pattern, but noise tolerance improves when the angles θz₁ and θz₂ are calculated from averages of the four alignment patterns.

Next, the reference z₁₀ for the first grating 104 and the reference z₂₀ for the second grating 106 are obtained using the moiré fringe formed by X-rays that have passed through the alignment pattern 117a of the second grating 106 and the moiré fringe formed by X-rays that have passed through the alignment pattern 117c of the second grating 106 illustrated in FIGS. 15A to 15D. The positions of the first grating 104 and the second grating 106 along the z-axis when the periods of the moiré fringes formed by the alignment patterns 117a and 117c of the second grating 106 match are denoted by z₁₀ and z₂₀, and the references z₁₀ and z₂₀ are recorded on the memory 209. As illustrated in FIG. 15C, when the period of the moiré fringe formed by the alignment pattern 117c of the second grating 106 is shorter than the period of the moiré fringe formed by the alignment pattern 117a of the second grating 106, the first grating 104 is deviated from the reference position toward the X-ray source 101. Therefore, by moving the first grating 104 toward the second grating 106 along the z-axis, the first grating 104 may be disposed at the reference z₁₀. Instead of moving the first grating 104, the second grating 106 may be moved toward the first grating 104 along the z-axis. In addition, the same result may be obtained using a combination between the moiré fringes formed by the alignment patterns 117c and 117d of the second grating 106. Either the angle θz₀ or the position z₀ of each grating may be aligned first. Alternatively, the angle θz₀ and the position z₀ may be simultaneously aligned.

Finally, the reference x₁₀ for the first grating 104 is obtained using the moiré fringes formed by the alignment patterns 117a and 117b of the second grating 106 illustrated in FIGS. 15A to 15D. The reference x₁₀ for the first grating 104 does not have a desirable position. This is because the reference x₁₀ for the first grating 104 affects only the spatial position of the moiré fringe used to image the subject 103. For this reason, the reference x₁₀ for the first grating 104 may be an arbitrary position. Therefore, for example, the position of the first grating 104 when alignment for the first grating 104 other than the reference x₁₀ has been completed, the position of the first grating 104 when the first grating 104 has been mounted on the X-ray imaging apparatus 1, or the like may be used as the reference x₁₀, and such an arbitrary position is recorded on the memory 209 as the reference x₁₀. By performing the “alignment for correcting deviation from the references” while the subject 103 is being imaged, changes in the position x₁ of the first grating 104 may be reduced.

When the patterns of the first grating 104 and the second grating 106 according to this embodiment are one-dimensional as illustrated in FIG. 4, the alignment to a reference position y₁₀ is not necessary since the moiré fringes used to image the subject 103 do not move even when the first grating 104 and the second grating 106 move in the y direction. When the patterns of the first grating 104 and the second grating 106 are two-dimensional, however, alignment needs to be performed in two directions (x and y directions in this embodiment) in which the periods of the patterns are formed. Therefore, the reference positions (x₁₀, y₁₀) are set and the “alignment for correcting deviation from the references” is performed in the two directions. The setting of the reference position y₁₀ in the y direction may be set in the same manner as for the reference position x₁₀.

As in the first embodiment, however, when an “intermediate-field image”, a “bright-field image”, or a “dark-field image” is measured, the reference position x₁₀ of the first grating 104 needs to be set in the same manner as in the first embodiment.

As in the first embodiment, when an X-ray source having a large focus size of hundreds of micrometers is used in this embodiment, the third grating 112 needs to be provided. Alignment of the source grating 112 in this case may be performed in the same manner as the alignment of the first grating 104 and the second grating 106. As in the first embodiment, the alignment of the third grating 112 may be performed by analyzing the positions of the centers of gravity of alignment patterns.

In this embodiment, it is not desirable that the subject 103 is detected by the second to fifth detectors 109 to 114 since the “alignment for determining the references” and the “alignment for correcting deviation from the references” are performed using the moiré fringes formed by the alignment patterns. This is because if the subject 103 enters the alignment patterns, it becomes difficult to distinguish the amounts of movement of the moiré fringes formed by the alignment patterns due to diffraction caused by the subject 103 and the amounts of movement of the moiré fringes formed by the alignment patterns due to movement of each grating. Therefore, in this embodiment, the “alignment for determining the references” may be performed before the subject 103 is disposed in the X-ray imaging apparatus 1. In addition, by disposing the subject 103 when the gratings are located at the reference positions and performing the “alignment for correcting deviation from the references” using the periods of the alignment patterns as the references for the gratings, no problem arises even if the subject 103 is detected by the second to fifth detectors 109 to 114. As in the first embodiment, however, the subject 103 may be kept from entering the alignment patterns as much as possible.

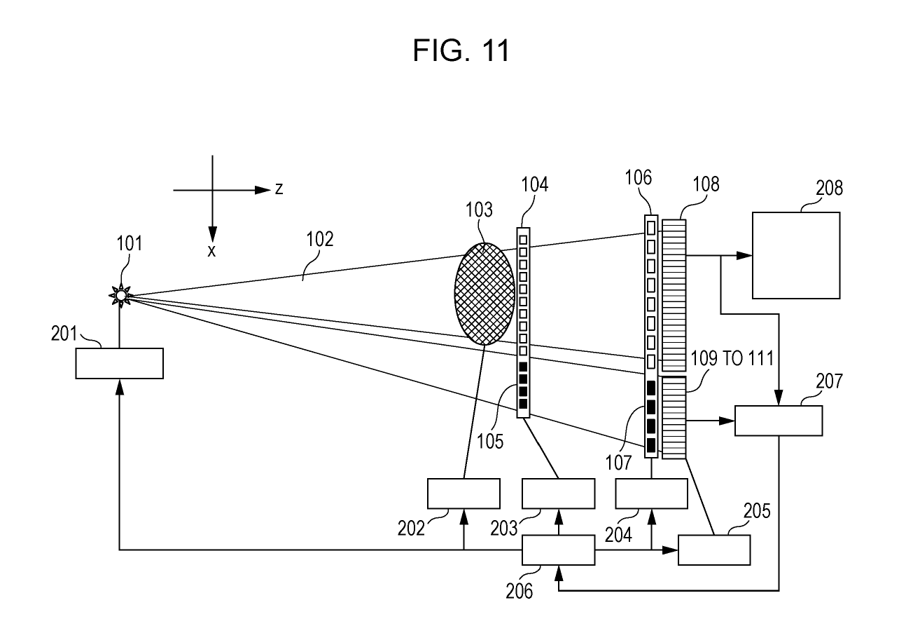

Although the four alignment patterns (a) to (d) are provided for each grating in this embodiment, alignment of each grating may be performed even when three alignment patterns are used. When only one alignment pattern is set, the second grating 106 needs to be fixed relative to the first detector 108 and the second detector 109 and it has to be made sure that the second grating 106 does not move while the subject 103 is being imaged. Although the alignment patterns are arranged away from one another in this embodiment, the alignment patterns may be arranged close to one another as illustrated in FIG. 11, and a plurality of alignment patterns may be analyzed using only the second detector 109.

### Example 1

In this example, a more specific example of the first embodiment will be described. In this example, a rotating target X-ray generation device composed of molybdenum is used as the X-ray source 101. The X-ray source 101 generates divergent X-ray beams 102, and the X-ray beams 102 enter the first grating 104, the second grating 106, and the first detector 108 or the second to fourth detectors 109 to 111 in this order. The period of the pattern of the first grating 104 is 6.1 μm, and the amount of phase modulation is a quarter of the Kα1 wavelength of molybdenum. The period of the pattern of the second grating 106 is 8.2 μm, and the X-ray screening ratio is 80%.

Three or more gold spheres are fixed to regions outside a grating region of each of the first grating 104 and the second grating 106 in the same plane as each of the first grating 104 and the second grating 106 as the alignment marks. The diameters of the gold spheres may be larger than the pixel sizes of the second to fourth detectors 109 to 111. Because the diameters of the spheres affect X-ray absorptance, the diameters may be 100 μm or more.

When a moiré fringe having a period of 200 μm is to be formed on the first detector 108 using a difference between the period of the self-image formed on the second grating 106 and the period of the second grating 106, the distance between the X-ray source 101 and the first grating 104 may be 116 cm and the distance between the first grating 104 and the second grating 106 may be 34 cm. At this time, however, the direction of the pattern of the first grating 104 and the direction of the pattern of the second grating 106 are assumed to match. When the moiré fringe is adjusted by rotating each grating, the distance between the X-ray source 101 and the first grating 104 is adjusted to 102.5 cm, the distance between the first grating 104 and the second grating 106 is adjusted to 35.3 cm, and the first grating 104 is rotated in plane by 2.35 degrees relative to the second grating 106. When the desired period is infinite, the distance between the X-ray source 101 and the first grating 104 is adjusted to about 102.5 cm, the distance between the first grating 104 and the second grating 106 is adjusted to 35.3 cm, and the direction of the period of the first grating 104 and the direction of the period of the second grating 106 are matched.

In the “alignment for determining the references”, the accuracy of the above geometry may be about 1 mm and 0.1 degree.

As the “alignment for determining the references”, the first grating 104 and the second grating 106 are disposed at the reference positions using the method according to the first embodiment in order to obtain the period of the moiré fringe necessary in this example. If an “intermediate-field image”, a “bright-field image”, or a “dark-field image” is obtained, the first grating 104 are aligned to the references x₁₀ and y₁₀ as necessary.

In the “alignment for correcting deviation from the references”, the second to fourth detectors 109 to 111 detect the alignment marks a plurality of times while the first detector 108 is detecting information regarding the subject 103 once. Every time the detection is performed, movement of the centers of gravity of the alignment marks is calculated using the method according to the first embodiment, and the first grating 104 and the second grating 106 are aligned on the basis of results of the calculation.

### Example 2

In this example, a more specific example of the second embodiment will be described. In this example, a rotating target X-ray generation device composed of molybdenum is used as the X-ray source 101. The X-ray source 101 generates divergent X-ray beams 102, and the X-ray beams 102 enter the first grating 104, the second grating 106, and the first detector 108 or the second to fifth detectors 109 to 114 in this order. The periods of the patterns of the first grating 104 are 6.1 μm, and the amount of phase modulation is a quarter of the Kα1 wavelength of molybdenum. The periods of the patterns of the second grating 106 are 8.2 μm, and the X-ray screening ratio is 80%.

In the first embodiment, it is difficult to adjust the period of the moiré fringe detected by the first detector 108 to a period longer than the length of the detection range of the first detector 108 since the adjustment of the period of the moiré fringe detected by the first detector 108 uses the moiré fringe detected by the first detector 108. On the other hand, in the second embodiment, even when the periods of the moiré fringes detected by the first detector 108 are longer than the length of the detection range of the first detector 108, the periods of the moiré fringes detected by the second to fifth detectors 109 to 114 may be adjusted to be shorter than the lengths of the detection ranges of the second to fifth detectors 109 to 114. Therefore, it becomes possible to easily adjust the periods of the moiré fringes obtained by imaging the subject 103 compared to the first embodiment.

For example, when the periods of the moiré fringes detected by the first detector 108 are to be infinite (L1 is adjusted to about 102.5 cm and L2 is adjusted to 35.3 cm), the periods of the moiré fringes detected by the second to fifth detectors 109 to 114 may be hundreds of micrometers.

For example, a case will be described in which the periods of the alignment patterns are adjusted to be the same as the periods of the gratings and the amounts of phase modulation of the alignment patterns of the first grating 104 are adjusted to a quarter of the Kα1 wavelength of molybdenum.

By making the direction of the period of the second grating 106 and the directions of the periods of the alignment patterns 117 of the second grating 106 different from each other by 6 degrees, the periods of the moiré fringes formed by the alignment patterns 117 become about 80 μm even when the periods of the moiré fringes formed on the first detector 108 are infinite. Similarly, by making the directions different from each other by 2.4 degrees, the periods of the moiré fringes formed by the alignment marks 107 become about 200 μm, and by making the directions different from each other by 1.2 degrees, the periods of the moiré fringes formed by the alignment patterns 117 become about 400 μm. Thus, the periods of the moiré fringes formed by the alignment patterns 117 may be adjusted in accordance with the pixel sizes of the second to fifth detectors 109 to 114.

Next, a case in which the directions of the periods of the alignment patterns 117 and the direction of the period of each grating are the same will be described. By making the period of the second grating 106 and the periods of the alignment patterns 117 of the second grating 106 different from each other by about 4%, the periods of the moiré fringes formed by the alignment patterns 117 become about 200 μm even when the periods of the moiré fringes formed on the first detector 108 are infinite. In this embodiment, as illustrated in FIG. 13B, the directions of the periods of the alignment patterns 117 of the second grating 106 are inclined toward the direction of the period of the second grating 106, and the periods of the alignment patterns 117 of the second grating 106 are different from the period of the second grating 106.

The periods of the moiré fringes formed on the first detector 108 may be adjusted to arbitrary periods using the above-described gratings. When the periods of the moiré fringes formed on the first detector 108 are to be 200 μm, the gratings may be aligned such that the periods of the moiré fringes formed on the first detector 108 become infinite, and then the angle θz₁ of the first grating 104 may be rotated by 2.35 degrees or the position z₂ of the second grating 106 may be moved by 5 mm. Alternatively, by adjusting the period of the second grating 106 to be about 7.9 μm, the periods of the moiré fringes formed on the first detector 108 when the gratings are disposed at the reference positions may be 200 μm.

In general, as the period of a moiré fringe becomes shorter in a region lower than a Nyquist rate, the accuracy of the period and the initial phase in a Fourier analysis improves. On the other hand, when the period of a moiré fringe becomes shorter, the amplitude intensity of the fringe decreases due to the effect of the modulation transfer function (MTF) of a detector or the like and becomes susceptible to noise, thereby decreasing the accuracy of the period and the initial phase in the Fourier analysis. In this example, in order to make the Fourier analysis easier, the periods of the moiré fringes formed by the alignment patterns may be 2.5 to 10 times as long as the lengths of the pixels of the detectors that detect the alignment patterns.

In the “alignment for determining the references”, the first grating 104 and the second grating 106 are disposed at the reference positions using the method according to the second embodiment in order to obtain the periods of the moiré fringes necessary in this example. When an “intermediate-field image”, a “bright-field image”, or a “dark-field image” is obtained, the first grating 104 are aligned to the references x₁₀ and y₁₀ as necessary.

In the “alignment for correcting deviation from the references”, the second to fourth detectors 109 to 111 detect the alignment patterns a plurality of times while the first detector 108 is detecting information regarding the subject 103 once. Every time the detection is performed, movement of the centers of gravity of the alignment patterns is calculated using the method according to the first embodiment, and the first grating 104 and the second grating 106 are aligned on the basis of results of the calculation.

### Example 3

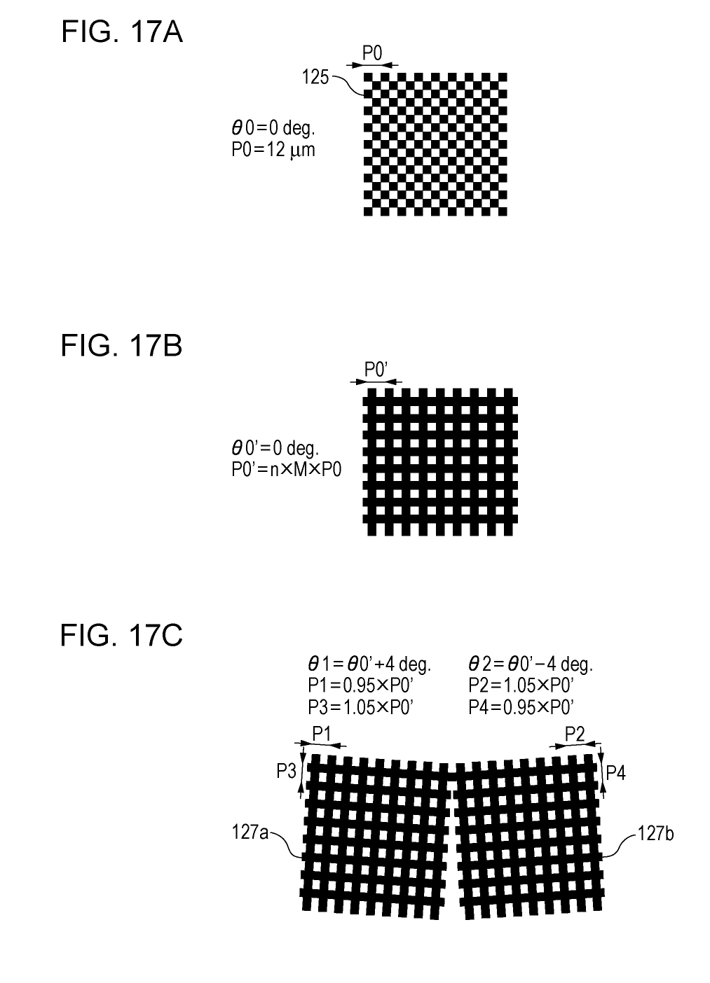

In the second embodiment, the alignment patterns having one-dimensional stripes are used to clarify the analysis method. However, the alignment patterns 117 of the second grating 106 may be one-dimensional or two-dimensional insofar as the periods or the directions of the periods of the alignment patterns 117 of the second grating 106 are different from the period or the direction of the period of the self-image formed by the first grating 104 on the second grating 106. In this example, a case in which two-dimensional alignment patterns illustrated in FIGS. 17A to 17C are used will be described. As illustrated in FIG. 17A, an alignment pattern 125 of the first grating 104 is a phase grating having a checkered pattern, and the period thereof is 12 μm and the amount of phase modulation thereof is half the Kα1 wavelength of molybdenum.

Because an interference pattern formed by the alignment pattern 125 of the first grating 104 illustrated in FIG. 17A at a Talbot distance is a check pattern illustrated in FIG. 17B, alignment patterns 127 of the second grating 106 may have a check pattern illustrated in FIG. 17C. In addition, the periods of the alignment patterns 127 of the second grating 106 are different from the period of the self-image formed by the alignment pattern 125 of the first grating 104 on the alignment patterns 127 of the second grating 106 by +5% and −5%, respectively, in the two-dimensional direction. Furthermore, the alignment patterns 127 of the second grating 106 are disposed in such a way as to be rotated by +4 degrees and −4 degrees, respectively, in the direction of the period of the self-image formed by the alignment pattern 125 of the first grating 104 on the alignment patterns 127 of the second grating 106.

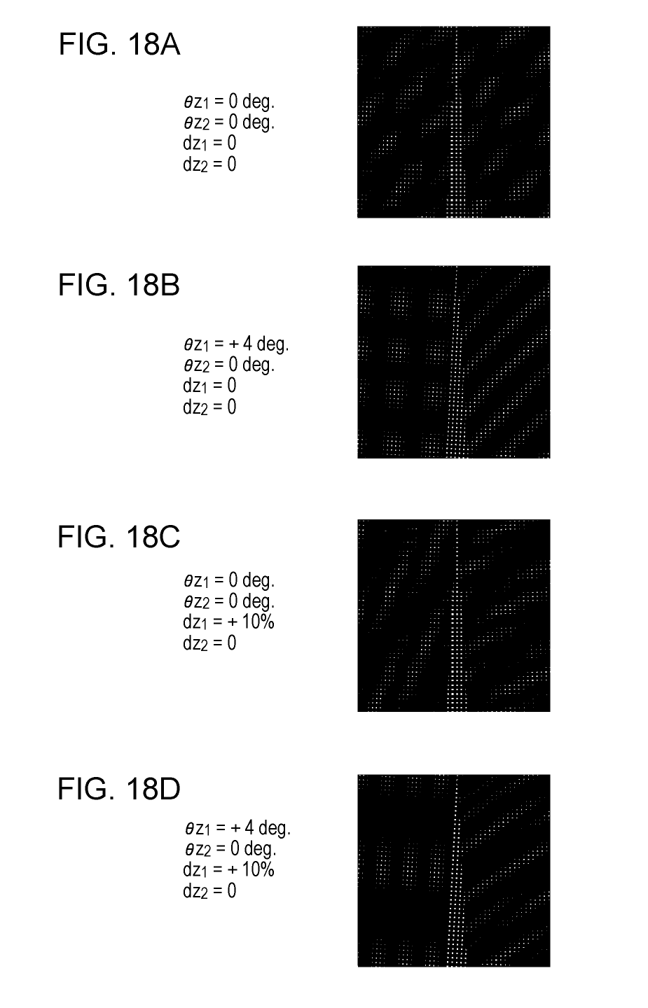

FIGS. 18A to 18D illustrate moiré fringes formed by the alignment pattern 125 of the first grating 104 and the alignment patterns 127 of the second grating 106. FIG. 18A illustrates moiré fringes at a time when the first grating 104 and the second grating 106 are disposed at the reference positions. A left part of FIG. 18A illustrates a moiré fringe formed by the alignment pattern 125 of the first grating 104 and an alignment pattern 127a of the second grating 106. A right part of FIG. 18A illustrates a moiré fringe formed by the alignment pattern 125 of the first grating 104 and an alignment pattern 127b of the second grating 106. FIG. 18B illustrates moiré fringes at a time when the angle θz₁ of the first grating 104 has been rotated clockwise from the state illustrated in FIG. 18A by 4 degrees. FIG. 18C illustrates moiré fringes at a time when the position z₁ of the first grating 104 has been moved from the state illustrated in FIG. 18A toward the X-ray source 101. FIG. 18D illustrates moiré fringes at a time when the angle θz₁ of the first grating 104 has been rotated clockwise from the state illustrated in FIG. 18A by 4 degrees and the position z₁ of the first grating 104 has been moved toward the X-ray source 101.

As in Example 2, the alignment of each grating may be performed by analyzing the periods and the directions of the periods of the four moiré fringes using the method according to the second embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-244598 filed Nov. 6, 2012, which is hereby incorporated by reference herein in its entirety.

What is claimed is:

1. An X-ray imaging apparatus comprising:
an optical device configured to form a periodic pattern using X-rays radiated from an X-ray source;
an alignment mark of the optical device;
a first detector configured to detect X-rays that have passed through the optical device and a subject;
a second detector configured to detect X-rays that have passed through the alignment mark; and
a movement unit configured to move the optical device on the basis of a result of the detection performed by the second detector.

2. The X-ray imaging apparatus according to claim 1,
wherein the detection of X-rays by the second detector and the movement of the optical device based on the result of the detection performed by the second detector are performed a plurality of times while the first detector is performing the detection once.

3. The X-ray imaging apparatus according to claim 1,
wherein the alignment mark is formed on a substrate of the optical device.

4. The X-ray imaging apparatus according to claim 1, further comprising:
a calculator configured to obtain at least either information regarding a position of the optical device or information regarding an angle of the optical device on the basis of the result of the detection performed by the second detector,
wherein the movement unit moves the optical device on the basis of at least either the information regarding the position of the optical device or the information regarding the angle of the optical device.

5. The X-ray imaging apparatus according to claim 1, further comprising:
a calculator configured to obtain information regarding the subject on the basis of a result of the detection performed by the first detector.

6. The X-ray imaging apparatus according to claim 1, further comprising:
a calculator configured to obtain information regarding the subject on the basis of a result of the detection performed by the first detector; and
a calculator configured to obtain at least either information regarding a position of the optical device or information regarding an angle of the optical device on the basis of the result of the detection performed by the second detector,
wherein the second detector transmits, a plurality of times, the result of the detection performed by the second detector to the calculator that calculates at least either the information regarding the position of the optical device or the information regarding the angle of the optical device while the first detector is transmitting, once, the result of the detection performed by the first detector to the calculator that calculates the information regarding the subject.

7. The X-ray imaging apparatus according to claim 6,
wherein the calculator that obtains at least either the information regarding the position of the optical device or the information regarding the angle of the optical device is a calculator that obtains the information regarding the subject.

8. The X-ray imaging apparatus according to claim 1, further comprising:
a first optical device and a second optical device as optical devices;
a first alignment mark of the first optical device; and
a second alignment mark of the second optical device,
wherein the second detector detects X-rays that have passed through the first alignment mark and the second alignment mark, and
wherein the movement unit changes at least either relative positions of the first optical device and the second optical device or relative angles of the first optical device and the second optical device by moving at least either the first optical device or the second optical device on the basis of the result of the detection performed by the second detector.

9. The X-ray imaging apparatus according to claim 2, further comprising:
a first optical device and a second optical device as optical devices;
a first alignment mark of the first optical device; and
a second alignment mark of the second optical device,
wherein the second detector detects X-rays that have passed through the first alignment mark and the second alignment mark, and
wherein the movement unit changes at least either relative positions of the first optical device and the second optical device or relative angles of the first optical device and the second optical device by moving at least either the first optical device or the second optical device on the basis of the result of the detection performed by the second detector.

10. The X-ray imaging apparatus according to claim 6, further comprising:
a first optical device and a second optical device as optical devices;
a first alignment mark of the first optical device; and
a second alignment mark of the second optical device,
wherein the second detector detects X-rays that have passed through the first alignment mark and the second alignment mark, and
wherein the movement unit changes at least either relative positions of the first optical device and the second optical device or relative angles of the first optical device and the second optical device by moving at least either the first optical device or the second optical device on the basis of the result of the detection performed by the second detector.

11. The X-ray imaging apparatus according to claim 8,
wherein the first optical device is a diffraction grating,
wherein the second optical device is an absorption grating,
wherein the first alignment mark is a diffraction grating that forms a periodic pattern, and
wherein the second alignment mark is an absorption grating that screens part of the X-rays.

12. The X-ray imaging apparatus according to claim 1,
wherein the alignment mark includes a region in which intensity of the X-rays is modulated.

13. An X-ray imaging system comprising:
the X-ray imaging apparatus according to claim 1; and
an X-ray source.
